(19) United States
(12) Patent Application Publication
(10) Pub. No.: US 2024/0060519 A1
(43) Pub. Date: Feb. 22, 2024

(54) PERFORMANCE IMPROVEMENTS FOR SOFT HYDRAULIC ELECTROSTATIC ZIPPING ACTUATORS

(71) Applicant: Artimus Robotics Inc., Boulder, CO (US)

(72) Inventors: Eric Lucas Acome, Longmont, CO (US); Nicholas Alexander Kellaris, Boulder, CO (US); Shane Karl Mitchell, Boulder, CO (US)

(73) Assignee: Artimus Robotics Inc., Boulder, CO (US)

(21) Appl. No.: 18/234,688

(22) Filed: Aug. 16, 2023

Related U.S. Application Data
(60) Provisional application No. 63/398,476, filed on Aug. 16, 2022.

(51) Int. Cl. F15B 21/06; F15B 15/10

(52) U.S. Cl. CPC F15B 21/065; F15B 15/10; F15B 2215/30

(57) ABSTRACT

A method for operating an actuator system includes providing an actuator with a deformable shell defining an enclosed internal cavity, a fluid dielectric, and first and second electrodes disposed over opposing sides of the enclosed internal cavity, and providing a power source such that the actuator system exhibits a first operational performance. Further, the method includes modifying at least one of length, width, diameter, and shape of the deformable shell and/or the first and second electrodes, a volume of the fluid dielectric, permittivity, thickness, and material of the deformable shell, and a partition within the deformable shell such that the actuator so modified exhibits a second operational performance. The operational performance includes force as a function of stroke, actuator breakdown strength, direction of actuation, uniformity of deformation of the deformable shell, actuator flexibility, and stroke as a function of actuator system volume.

### REFERENCE TO RELATED APPLICATIONS

The present application claims the benefit of U.S. Provisional Pat. App. No. 63/398,476, filed 2022 Aug. 16 and titled “Performance Improvements for Soft Hydraulic Electrostatic Zipping Actuators,” which application is incorporated hereby in its entirety by reference.

### FIELD OF THE INVENTION

The present invention relates to actuators. In particular, but not by way of limitation, the present invention relates to soft hydraulic electrostatic actuators.

### DESCRIPTION OF RELATED ART

Various forms of Hydraulically Amplified Self-Healing Electrostatic (HASEL) actuators have been described in the past. For instance, the following patent applications describe HASEL actuators and variations: PCT Publication No. WO 2018/175741, filed on 2018 Mar. 22 and titled “HYDRAULICALLY AMPLIFIED SELF-HEALING ELECTROSTATIC TRANSDUCERS;” PCT Application No. PCT/US2019/020568, filed on 2019 Mar. 4 and titled “HYDRAULICALLY AMPLIFIED SELF-HEALING ELECTROSTATIC TRANSDUCERS HARNESSING ZIPPING MECHANISM;” PCT Application No. PCT/US20/20986, filed 2020 Mar. 4 and titled “FOLDABLE FILLING FABRICATION AND COMPOSITE LAYERING OF HYDRAULICALLY AMPLIFIED SELF-HEALING ELECTROSTATIC TRANSDUCERS;” PCT Application No. PCT/US20/20978, filed 2020 Mar. 4 and titled “COMPOSITE LAYERING OF HYDRAULICALLY AMPLIFIED SELF-HEALING ELECTROSTATIC TRANSDUCERS;” PCT Application No. PCT/US2020/046494, filed 2020 Aug. 14 and titled “HYDRAULICALLY AMPLIFIED SELF-HEALING ELECTROSTATIC (HASEL) PUMPS;” and PCT Application No. PCT/US21/35041, filed 2021 May 29 and titled “CAPACITIVE SELF-SENSING FOR ELECTROSTATIC TRANSDUCERS WITH HIGH VOLTAGE ISOLATION.” All of the above referenced patent applications are incorporated hereby in their entirety by reference.

### SUMMARY OF THE INVENTION

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In an aspect, methods for modifying the performance of soft hydraulic electrostatic zipping actuators, such as hydraulically-amplified self-healing electrostatic (HASEL) actuators, are presented. These methods may include modifying the materials, geometry, or other intrinsic features of the actuators to modify stroke, force, or other important characteristics such as reliability.

In an embodiment, a method for adjusting an operational performance of an actuator system is disclosed. The method includes providing an actuator including a deformable shell defining an enclosed internal cavity, a fluid dielectric contained within the enclosed internal cavity, a first electrode disposed over a first side of the enclosed internal cavity, and a second electrode disposed over a second side of the enclosed internal cavity. The method further includes providing a power source for providing a voltage across the enclosed internal cavity between the first and second electrodes. The method additionally includes adjusting the operational performance of the actuator by modifying at least one of:
a length, width, diameter, and shape of the deformable shell,
a length, width, diameter, and shape of at least one of the first and second electrodes,
a ratio of area covered by the first and second electrodes to a surface area of the deformable shell,
a ratio of the length, width, and diameter of the deformable shell to the length, width, and diameter of at least one of the first and second electrodes,
a ratio of a volume of the fluid dielectric to a volume capacity of the enclosed internal cavity,
a permittivity of at least a portion of the deformable shell,
a thickness of at least a portion of the deformable shell,
a material forming the deformable shell under at least one of the first and second electrodes,
a material forming the deformable shell in areas not covered by the first and second electrodes,
at least one edge configuration of the deformable shell,
an edge configuration of at least one of the first and second electrodes, and
a partition within at least a portion of the deformable shell.

The operational performance includes force provided by the actuator as a function of stroke, actuator breakdown strength, direction of actuation, uniformity of deformation of the deformable shell, actuator flexibility, and stroke as a function of actuator system volume.

In a further embodiment, the method includes providing a stiff plate adjacent to the actuator for transmitting force therethrough. In a still further embodiment, the method includes providing additional actuators, and configuring the stiff plate to also be adjacent to the additional actuators.

In an alternative embodiment, the method further includes modifying a shape of a portion of the deformable shell to promote the deformable shell to take on a predefined shape upon application of the voltage across the enclosed internal cavity.

In another embodiment, a method for operating an actuator system includes providing an actuator with a deformable shell defining an enclosed internal cavity, a fluid dielectric, and first and second electrodes disposed over opposing sides of the enclosed internal cavity, and providing a power source such that the actuator system exhibits a first operational performance. Further, the method includes modifying at least one of length, width, diameter, and shape of the deformable shell and/or the first and second electrodes, a volume of the fluid dielectric, permittivity, thickness, and material of the deformable shell, and a partition within the deformable shell such that the actuator so modified exhibits a second operational performance. The operational performance includes force as a function of stroke, actuator breakdown strength, direction of actuation, uniformity of deformation of the deformable shell, actuator flexibility, and stroke as a function of actuator system volume.

In a further embodiment, the modifying includes providing a second actuator disposed adjacent to the actuator, first mentioned, wherein the second actuator is connected in series with the actuator, first mentioned.

In still another embodiment, the method also includes providing a stiff plate disposed over both the actuator, first mentioned, and the second actuator for transmitting force from the actuator, first mentioned, and the second actuator therethrough.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1A illustrates a simplified cross section of a hydraulically amplified soft electrostatic (HASEL) actuator at rest, in accordance with an embodiment.

FIG. 1B illustrates a simplified cross section of a HASEL actuator at an intermediate voltage with electrodes partially zipped, in accordance with an embodiment.

FIG. 1C illustrates a simplified cross section of a HASEL actuator at a maximum voltage with electrodes fully zipped, in accordance with an embodiment.

FIG. 2A shows a cross-sectional view of the HASEL actuator of FIG. 1A, shown here to illustrate an angle between the electrodes.

FIG. 2B shows a cross-sectional view of the HASEL actuator of FIG. 1B, shown here to illustrate the differences in the angle and zipped length of the electrodes when voltage V₁ is applied thereto.

FIG. 3A shows a front view of a contracting HASEL actuator, in accordance with an embodiment.

FIG. 3B shows a cross-sectional side view of the contracting HASEL actuator of FIG. 3A.

FIG. 3C shows a front view of the contracting HASEL actuator of FIG. 3A, shown here in a contracted state.

FIG. 3D shows a cross-sectional side view of the contracting HASEL actuator of FIG. 3C.

FIG. 4A shows a perspective view of two configurations of contracting HASEL actuators, in accordance with embodiments.

FIG. 4B shows a graph of actuator force as a function of stroke for different numbers of pouches in the actuator set.

FIG. 5A shows a perspective view of two additional configurations of contracting HASEL actuators, in accordance with embodiments.

FIG. 58 shows a graph of the actuator force as a function of stroke for different numbers of sets of actuators that are stacked.

FIG. 6A shows a perspective view of two further configurations of contracting HASEL actuators, in accordance with embodiments.

FIG. 6B shows a graph of the actuator force as a function of stroke for different pouch lengths used in the actuator configurations.

FIG. 7A shows a perspective view of two more configurations of contracting HASEL actuators, in accordance with embodiments.

FIG. 7B shows a graph of the actuator force as a function of stroke for different pouch widths used in the actuator configurations.

FIG. 8A shows a perspective view of two HASEL actuators with different electrode coverage, in accordance with embodiments.

FIG. 8B shows a graph of the actuator force as a function of stroke for different electrode coverage used in the actuator configurations.

FIG. 9A shows a perspective view of two HASEL actuators with different fill volumes, in accordance with embodiments.

FIG. 9B shows a graph of the actuator force as a function of stroke for different fill volumes used in the actuator configurations.

FIG. 10A shows a perspective view of two HASEL actuators with different pouch film dielectric properties, in accordance with embodiments.

FIG. 1013 shows a graph of the actuator force as a function of stroke for different film dielectric properties used in the actuator configurations.

FIG. 11A shows a perspective view of two HASEL actuators with different pouch film thicknesses, in accordance with embodiments.

FIG. 11B shows a graph of the actuator force as a function of stroke for different film thicknesses used in the actuator configurations.

FIG. 12A shows a top view of a circular expanding HASEL actuator, in accordance with embodiments.

FIG. 12B shows a cross-sectional view of the circular expanding HASEL actuator of FIG. 12A, shown here with no voltage applied thereto.

FIG. 12C shows a cross-sectional view of the circular expanding HASEL actuator of FIGS. 12A and 12B, shown here with a voltage V₂ applied thereto.

FIG. 13A shows a perspective view of two configurations of HASEL actuators with different numbers of actuators in each configuration, in accordance with embodiments.

FIG. 13B shows a graph of the actuator force as a function of stroke for different numbers of actuators stacked in the actuator configurations.

FIG. 14A shows a perspective view of two configurations of HASEL actuators with different numbers of actuators and stacks in each configuration, in accordance with embodiments.

FIG. 14B shows a graph of the actuator force as a function of stroke for different numbers of actuators and stacks in the actuator configurations.

FIG. 15A shows a perspective view of a column of HASEL actuators including stiff plates interspersed therein, in accordance with embodiments.

FIG. 15B shows a cross-sectional view of the column of HASEL actuators of FIG. 15A, shown here with voltage turned off.

FIG. 15C shows a cross-sectional view of the column of HASEL actuators of FIGS. 15A and 15B, shown here with voltage turned on.

FIG. 15D shows a perspective view of a four-column configuration of HASEL actuators including stiff plates interspersed therein, in accordance with embodiments.

FIG. 15E shows a cross-sectional view of the four-column configuration of HASEL actuators of FIG. 15E, shown here with voltage turned off.

FIG. 15F shows a cross-sectional view of the four-column configuration of HASEL actuators of FIGS. 15D and 15E, shown here with voltage turned on.

FIG. 16A shows a perspective view of two configurations of HASEL actuators with different diameters in each configuration, in accordance with embodiments.

FIG. 16B shows a graph of the actuator force as a function of stroke for different diameters of actuators in the configurations.

FIG. 17A shows a perspective view of two expanding HASEL actuators with different electrode coverage, in accordance with embodiments.

FIG. 17B shows a graph of the actuator force as a function of stroke for different electrode coverage used in the expanding actuator configurations.

FIG. 18A shows a perspective view of two expanding HASEL actuators with different fill volumes, in accordance with embodiments.

FIG. 18B shows a graph of the actuator force as a function of stroke for different fill volumes used in the expanding HASEL actuator configurations.

FIG. 19A shows a perspective view of two expanding HASEL actuators with different pouch film permittivity values, in accordance with embodiments.

FIG. 19B shows a graph of the actuator force as a function of stroke for different film permittivity values used in the expanding HASEL actuator configurations.

FIG. 20A shows a perspective view of two expanding HASEL actuators with different pouch film thicknesses, in accordance with embodiments.

FIG. 20B shows a graph of the actuator force as a function of stroke for different film thicknesses used in the expanding HASEL actuator configurations.

FIG. 21A shows a contracting HASEL actuator with a rounded pouch end portion, in accordance with embodiments.

FIG. 21B shows a contracting HASEL actuator with a notched pouch end portion, in accordance with embodiments.

FIG. 21C shows a contracting HASEL actuator with an inwardly-curved pouch end portion, in accordance with embodiments.

FIG. 21D shows a contracting HASEL actuator with a pointed pouch end portion, in accordance with embodiments.

FIG. 21E shows a contracting HASEL actuator with an inwardly-notched pouch end portion, in accordance with embodiments.

FIG. 21F shows a contracting HASEL actuator with a scalloped pouch end portion, in accordance with embodiments.

FIG. 21G shows a contracting HASEL actuator with a scalloped pouch end portion as well as electrode edge, in accordance with embodiments.

FIG. 22A shows a front view of a contracting HASEL actuator including relief cuts, in accordance with embodiments.

FIG. 22B shows a cross-sectional view of the contracting HASEL actuator of FIG. 22A, without a voltage applied thereto.

FIG. 22C shows a front view of the contracting HASEL actuator of FIGS. 22A and 22B, with a voltage applied thereto.

FIG. 22D shows a cross-sectional view of the contracting HASEL actuator of FIGS. 22A-22C with applied voltage.

FIG. 22E shows a cross-sectional view of the pouch portion of the contracting HASEL actuator of FIGS. 22C and 22D with applied voltage.

FIG. 23A shows a front view of a contracting HASEL actuator including two different materials in the electrode and uncovered regions, in accordance with embodiments.

FIG. 23B shows a cross-sectional view of the contracting HASEL actuator of FIG. 23A.

FIG. 24A shows a front view of a rectangular HASEL actuator including a dielectric coating, in accordance with embodiments.

FIG. 24B shows a front view of a rectangular HASEL actuator including a dielectric applied under the electrodes over the heat seal portion, in accordance with embodiments.

FIG. 24C shows a front view of a rectangular HASEL actuator including a dielectric applied under the electrode edges, in accordance with embodiments.

FIG. 24D shows a front view of a rectangular HASEL actuator including an annular dielectric pattern, in accordance with embodiments.

FIG. 25 shows a front view of a rectangular HASEL actuator including a wide pouch, in accordance with embodiments.

FIG. 26 shows a top view of a circular HASEL actuator including a scalloped edge, in accordance with embodiments.

FIG. 27 shows a variation of the expanding actuator of FIG. 26, in accordance with an embodiment.

FIG. 28A shows a perspective view of a multi-pouch actuator, shown here to illustrate a common failure point for actuator pouches connected in series.

FIG. 28B shows a front view of a portion of an actuator pouch with another view of a common location of failure.

FIG. 29A shows a perspective view of multiple actuators connected in series, in accordance with embodiments.

FIG. 29B shows a cross-sectional view of the actuators of FIG. 29A.

FIG. 29C shows a perspective view of the actuators of FIG. 29A with a dielectric coating, in accordance with embodiments.

FIG. 29D shows a cross-sectional view of the actuators of FIG. 29C.

FIG. 29E. shows the actuators of FIG. 29C with electrodes connected therewith, in accordance with embodiments.

FIG. 29F shows a cross-sectional view of the actuators and electrodes of FIG. 29E.

FIG. 30A shows an array of rectangular actuators with triangular electrodes, in accordance with an embodiment.

FIG. 30B shows an array of rectangular actuators with an alternative arrangement of triangular electrodes, in accordance with an embodiment.

FIG. 30C shows an array of rectangular actuators with still another arrangement of triangular electrodes, in accordance with an embodiment.

FIG. 30D shows an array of rectangular actuators with yet another arrangement of triangular electrodes, in accordance with an embodiment.

FIG. 31A shows an actuator pouch with semi-circular electrodes and rounded pouch edges, in accordance with an embodiment.

FIG. 31B shows multiple actuators of FIG. 30A, connected in series.

FIG. 32 shows an array of rectangular actuators with triangular electrodes, in accordance with an embodiment.

FIG. 33 shows an array of triangular actuators with rectangular electrodes, in accordance with an embodiment.

FIG. 34A shows a stack of expanding actuators, arranged in an alternating fashion, in accordance with embodiments.

FIG. 34B shows the stack of actuators of FIG. 34 with voltage applied to each actuator, in accordance with embodiments.

For simplicity and clarity of illustration, the drawing figures illustrate the general manner of construction, and descriptions and details of well-known features and techniques may be omitted to avoid unnecessarily obscuring the embodiments detailed herein. Additionally, elements in the drawing figures are not necessarily drawn to scale. For example, the dimensions of some of the elements in the figures may be exaggerated relative to other elements to help improve understanding of the described embodiments. The same reference numerals in different figures denote the same elements.

The word “exemplary” is used herein to mean “serving as an example, instance, or illustration.” Any embodiment described herein as “exemplary” is not necessarily to be construed as preferred or advantageous over other embodiments. In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or apparatuses. The following detailed description is therefore not to be taken in a limiting sense, and the scope of the present disclosure is defined by the appended claims and their equivalents.

### DETAILED DESCRIPTION OF THE INVENTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as “between” two layers, it can be the only layer between the two layers, or one or more intervening layers may also be present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “compromising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items and may be abbreviated as “/”.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present. Likewise, when light is received or provided “from” one element, it can be received or provided directly from that element or from an intervening element. On the other hand, when light is received or provided “directly from” one element, there are no intervening elements present.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

HASEL actuators show promise as soft electric actuators for a range of applications, each application having unique requirements. It is recognized herein that the performance of a HASEL actuator is influenced by various parameters, such as material properties of the actuator components and geometric factors. The present disclosure discusses these parameters and how they impact actuator performance. In many cases, these parameters may be adjusted to tune force and stroke, as well as other parameters such as reliability and cycle life. Modified soft hydraulic electrostatic zipping actuators, such as HASEL actuators, and methods for using such actuators as well as customizing the performance of soft hydraulic electrostatic zipping actuators for specific applications are presented. The modifications may include, and are not limited to, modifying the materials, geometry, and other intrinsic features of the actuators to modify stroke, force, or other important characteristics such as reliability.

The appended drawings illustrate only some implementations and are therefore not to be considered limiting of scope.

Basic Structure of Actuators

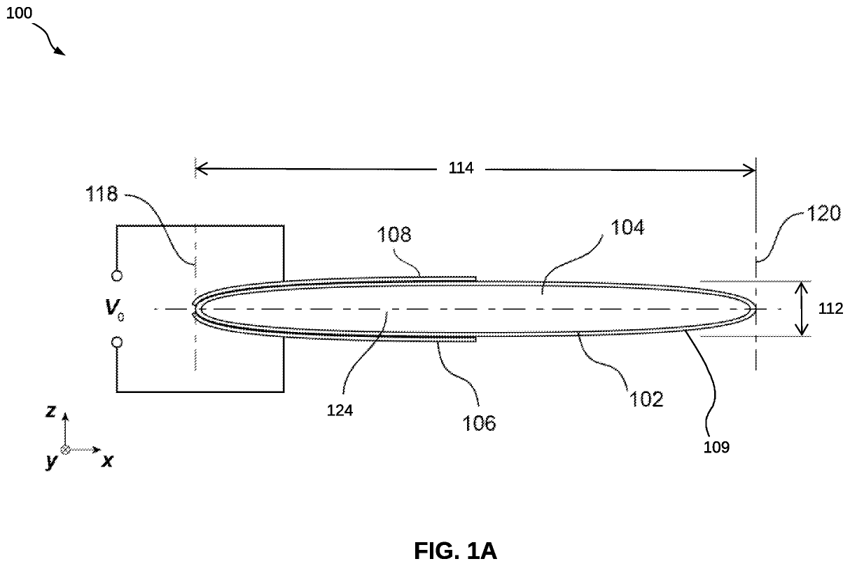

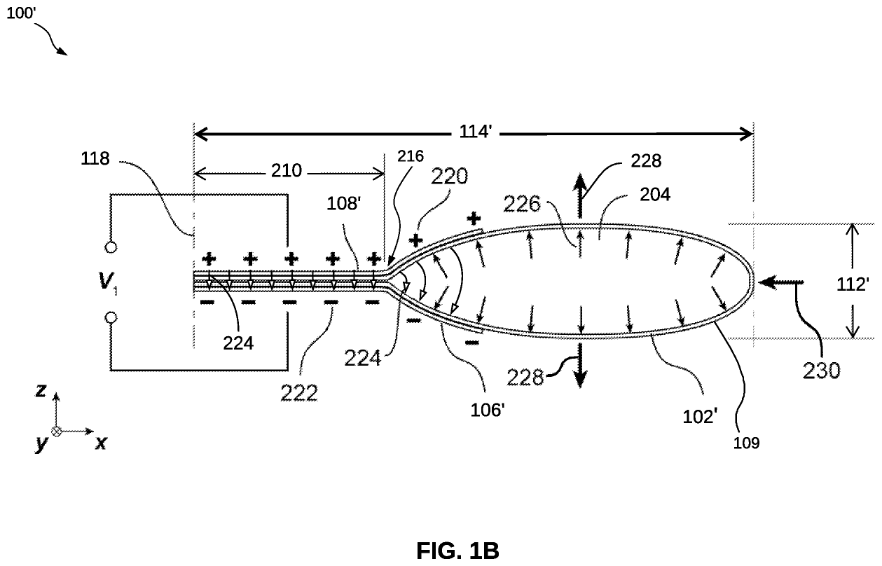

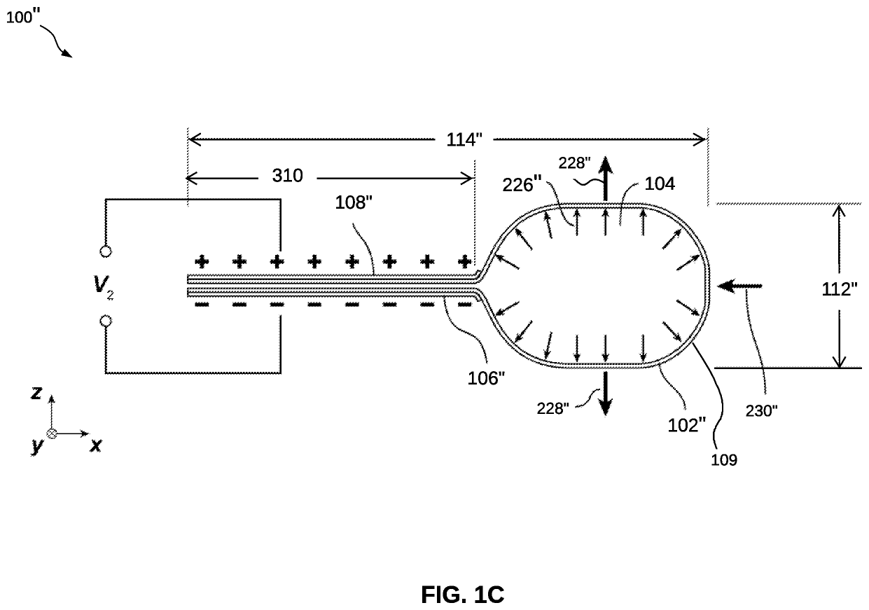

FIG. 1A illustrates a cross-sectional view of an exemplary structure of a HASEL actuator, shown without a voltage applied thereto shows an exemplary structure of a HASEL actuator 100. A flexible shell or pouch 102 defines an enclosed internal cavity that is filled with a liquid dielectric 104. For instance, flexible shell 102 may be formed of one or more dielectric material that is inextensible and/or elastically deformable. A first electrode 106 is disposed over a first side of the enclosed internal cavity and a second electrode 108 is disposed over a second side of the enclosed internal cavity opposite the first side. As shown in FIG. 1, first and second electrodes 106, 108 are disposed on opposing sides of shell 102, extending toward the tapered end of the shell, in an example.

In certain embodiments, an outer encapsulation layer 109, which may include a dielectric coating, may provide electrical insulation or protect the actuator from mechanical wear and tear. In embodiments, outer encapsulation layer 109 may be stretchable or flexible and may be provided with varying thicknesses. The outer encapsulation may also include a combination of materials, such as a liquid with an elastomer or polymer outer layer to contain the liquid therein.

In an initial state where an applied voltage V₀ is null or small, flexible shell 102 may exhibit an initial thickness 112 and length 114.

While FIG. 1A illustrates a cross-sectional view of an exemplary, basic HASEL structure, a variety of shapes may be formed with the equivalent combination of a flexible shell, dielectric fluid, and electrodes. For example, three-dimensional circular pouch shapes may be formed by revolving this cross-section around an axis at either a left boundary 118 or a right boundary 120, as an example. Likewise, this cross section can be extruded in a direction that is normal to the page to form a rectangular or oval pouch shape. Other pouch shapes may be contemplated based on this basic configuration where part of a flexible shell is covered by a pair of electrodes positioned on opposing sides of the flexible shell.

Multiple flexible shells 102 may be positioned adjacent to each other or connected together, such as at either left boundary 118 or right boundary 120, to form a multi-pouch actuator in a horizontal direction (i.e., x or y direction as shown in FIG. 1). Likewise, flexible shells may be stacked in the z direction to create a multi-pouch actuator stack. In certain examples, a solid plate may be positioned adjacent to the multi-pouch actuator stack or in between the pouches, such as shown in FIGS. 15A and 15B, as will be described at an appropriate juncture below.

Pouch length 114 may be varied depending on the application and desired performance. For instance, a pouch length ranging from 0.5 mm to 100 mm may be contemplated. As an example, initial thickness 112 may range from 0.1 mm to 10 mm. The length of each one of electrodes 108 and 106 is typically a fraction of pouch length 114 and may range from 10% to 90% of pouch length 114. As will be discussed in more detail below, dimensions of the pouch, the volume of dielectric liquid fill, the number of stacked or connected pouches, specific materials used to form the actuator, and other factors all influence the performance of the actuator system.

Flexible shell 102 may be made from one or more dielectric and non-dielectric layers with various thicknesses, in certain embodiments. A suitable polymer film for forming flexible shell 102 may include biaxially-oriented films such as polyester, polyethylene terephthalate, and polypropylene. Other suitable films may include polyvinylidene fluoride (PVDF), co-polymers, terpolymers (e.g., poly(vinylidene fluoride-trifluoroethylene-chlorotrifluoroethylene) (P(VDF-TrFE-CTFE)), polytetrafluoroethylene (PTFE), and thermoplastic polyurethane (TPU)). In certain embodiments, films with a dielectric permittivity greater than 2 and dielectric strength greater than 30 kV/mm may be selected. Films may be doped with nanoparticles such as titanium dioxide, barium titanate, and other semiconductor materials to increase permittivity and therefore increase actuator performance. Thickness of the film forming flexible shell 102 may be less than 50 μm, for example. Flexible shell 102 may be formed of multiple layers of dielectric materials to increase dielectric performance. Additionally, layers for providing improved mechanical performance may be laminated with the dielectric layer of the flexible shell. Flexible shell 102 may be formed from a variety of techniques including, and not limited to, heat-sealing, ultra-sonic sealing, adhesives, plasma treatment, laminating, and laser sealing.

Liquid dielectric 104 may include one or more fluids such as natural esters (e.g., FR3® natural ester dielectric fluid from Cargill, Inc.), silicone oils, and mineral oils to name a few. The fluid may be doped with nanoparticles such as titanium dioxide, barium titanate, and other semiconductor materials to increase permittivity and therefore influence actuator performance, in certain embodiments. In some embodiments, liquid dielectric 104 may be a dielectric gas or combination of gas and liquid. Volume of liquid within a pouch generally depends on pouch length and desired thickness and may range from 0.01 mL to 10 mL in each pouch. The actual volume of the liquid dielectric may be adjusted in accordance with desired performance, as discussed in further detail below.

Electrodes 106 and 108 may be selected from a number of conductive materials that may be applied by various processes. Electrodes may be flexible and stretchable, or in some cases fully or partially rigid. Possible materials include metallized films that are vacuum deposited onto flexible shell 102, screen-printed conductive inks, conductive elastomers, metals, and conductive polymers.

FIG. 1B illustrates a simplified cross section of a HASEL actuator at an intermediate voltage with electrodes partially zipped, in accordance with an embodiment. In particular, FIG. 18 illustrates a version 100′ of actuator 100 of FIG. 1A with a non-zero voltage V₁ applied such that a portion of electrodes 106′ and 108′ have zipped together in a portion 210 to push fluid 104 within shell 102′ and thickness 112′ has increased and length 114′ has decreased compared to the original thickness 112 and length 114.

In other words, applied voltage V₁ causes charges 220, 222 of opposing polarity to flow onto electrodes 106′ and 108′. Charges 220, 222 act to induce an electric field 224 (represented by white-headed arrows) through flexible shell 102′ and liquid dielectric 104. Electric field 224 is generally concentrated through portion 210 where the electrodes have zipped together and through liquid dielectric 104 at the edge of a tapered boundary 216 where electrodes 106′ and 108′ are closest together. This concentration of electric field 224 causes the tapered region to experience a high electrostatic stress and, in response, electrodes 106, 108 zip or move closer together. As the electrodes zip together along portion 210, liquid dielectric 104 is displaced to the portion of flexible shell that has not zipped together. This displacement causes flexible shell 102 to deform such that a hydrostatic pressure 226 (indicated by arrows) of liquid dielectric 104 increases. The increased internal hydrostatic pressure 226 combined with the deformation of flexible shell 102′ imparts an expanding force in the vertical direction and a contracting force in the horizontal direction (indicated respectively by thick arrows 228 and 230, respectively). These forces and shape change may be used for performing mechanical work on external objects or surfaces.

FIG. 1C illustrates a simplified cross section of the HASEL actuator of FIGS. 1A and 18 at a maximum voltage with electrodes fully zipped, in accordance with an embodiment. Particularly, FIG. 1C shows actuator 100″ with voltage V₂ applied thereto, where V₂ is greater in magnitude than V₁ and is sufficient for complete zipping together of the electrodes. In this case, electrodes 106″, 108″ have fully zipped together, substantially from edge to edge. Liquid dielectric 104 contained in flexible shell 102″ has been displaced to the portion of the pouch not covered by electrodes, which causes the pouch to further deform and increases the value of hydrostatic pressure 226″. Consequently, length 114″ is reduced to a minimum value and thickness 112″ increases to a maximum value for the given configuration. Likewise, expanding force 228″ and contracting force 230″ increases, compared to expanding force 228 and contracting force 230 of FIG. 18. It is noted that, although FIGS. 18 and 1C are shown with a polarity with positive charges shown on top electrode (i.e., electrode 108′, 108″), the symmetry of the actuator is such that the polarity of the applied voltage may be reversed, in embodiments.

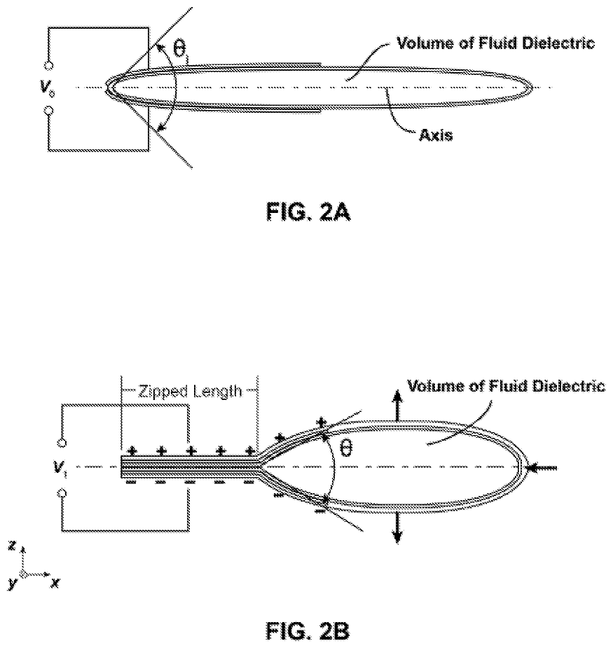

FIG. 2A shows a cross-sectional view of an actuator at rest, shown here to illustrate the geometry of the electrode zipping mechanics. When activated, i.e., when a non-zero voltage is applied across the electrodes, the actuator begins to zip at the edge of the pouch where the distance between the electrodes is smallest. At rest (i.e., with a substantially zero voltage V₀ applied across the electrodes, the angle between the electrodes is an initial angle θ, as shown in FIG. 2A.

FIG. 2B illustrates another cross-sectional view of the actuator of FIG. 2A at a non-zero voltage V₁ where the electrodes have zipped together by some zipped length. When a non-zero voltage is applied across the electrodes, the electrodes will zip together while displacing the volume of fluid dielectric until the overall system energy is minimized. In a simplified model, the contributions to system energy may include energy from a battery at voltage V₁, the electrical energy stored on the capacitor formed by the zipped electrodes, and the mechanical work from external loads. Previous work has shown that the system energy can be represented as a function of the zipping angle and for a given voltage and external load, the zipped length will increase until the zipping angle is large enough that it is no longer energetically favorable to continue zipping and the system reaches an equilibrium. In general, it is energetically easier to increase zipping length if the zipping angle, θ, is smaller than 90 degrees. For example, the initial zipping angle may be as small as 5 degrees.

Fundamentals of Contracting Actuators

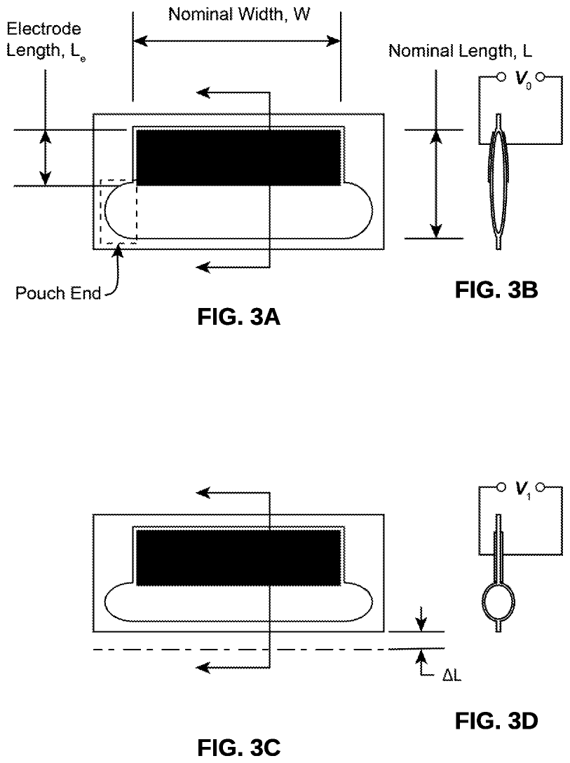

FIG. 3A shows a front view of a contracting HASEL actuator, in accordance with an embodiment. As shown in FIG. 3A, a rectangular HASEL actuator includes a geometry that is optimized for contracting in the length direction. The actuator of FIG. 3A has a nominal initial length, L, and width, W. Electrodes cover a portion of the pouch and in this case have same width as the pouch and length, L e that is a portion of the pouch length L. In this case a pouch end on either side of the pouch portion of the actuator includes a semi-circular shape. FIG. 3B shows a cross-sectional side view of the contracting HASEL actuator of FIG. 3A, showing the cross-sectional configuration of the pouch and electrodes when a substantially zero voltage V₀ is applied across the electrodes.

FIG. 3C shows a front view of the contracting HASEL actuator of FIG. 3A, shown here in a contracted state with a non-zero voltage V₁ applied across the electrodes. FIG. 3D shows a cross-sectional side view of the contracting HASEL actuator of FIG. 3C. As shown in FIGS. 3C and 3D, the electrodes have zipped together and the overall length of the actuator has decreased by ΔL.

Modifying Performance of Contracting Actuators

A variety of parameters of contracting actuators may be modified to tailor the performance of the actuator system. Some exemplary embodiments are described below.

1) Changing Number of Pouches in Series for More Stroke at a Given Force

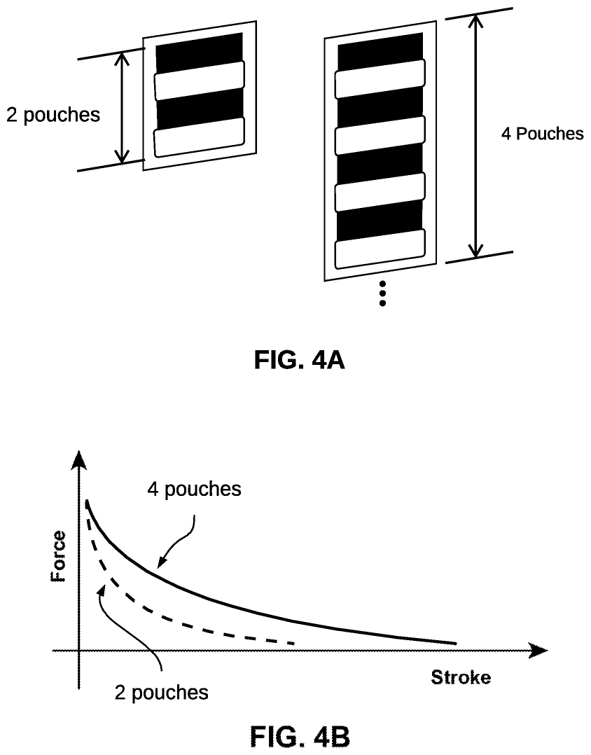

FIGS. 4A and 4B illustrate how performance of contracting actuators changes when the number of pouches (each pouch having the similar length as each other pouch) connected in series is modified. Increasing the number of pouches increases actuator stroke at a given force.

In particular, FIG. 4A shows a perspective view of two configurations of contracting HASEL actuators, in accordance with embodiments. An actuator with two contracting actuators connected in series is shown on the left side of FIG. 4A. The right side of FIG. 4A shows a different actuator with four pouches including four contracting actuators connected in series. Any number of additional actuators may be further connected, as indicated by three dots below the four-pouch actuator.

FIG. 4B shows a graph of actuator force as a function of stroke for different numbers of pouches in the actuator set. As shown in FIG. 4, actuator blocked force (i.e., force at 0 mm contraction stroke) is substantially the same for both the two- and four-pouch actuators. For a given force value, the effective stroke is increased with the number of additional pouches.

This variation may be useful for increasing force and/or stroke in cases where the length dimension is not limited, while there are constraints to the width and thickness of the actuator. It is noted that, due to the high length-to-thickness aspect ratio of such contracting actuators in series, increasing stroke is often limited by space constraints in the mechanical system into which the actuators are integrated.

2) Changing Number of Actuators in Parallel for More Force at a Given Stroke

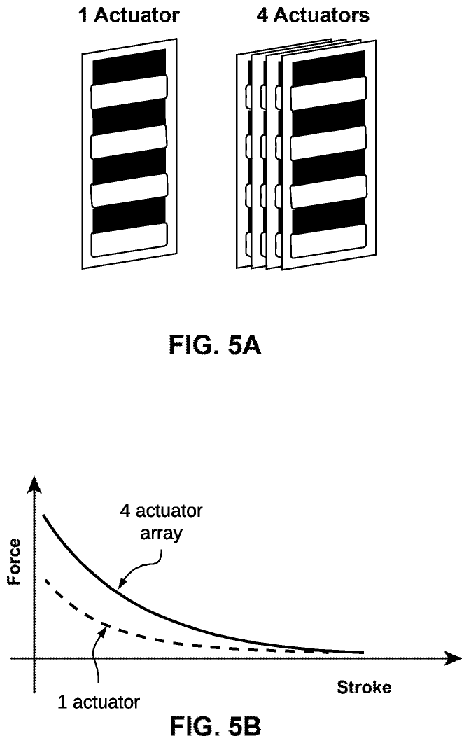

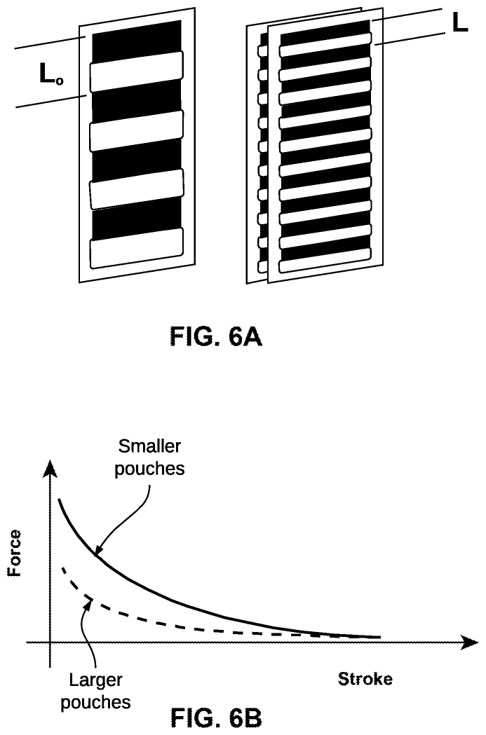

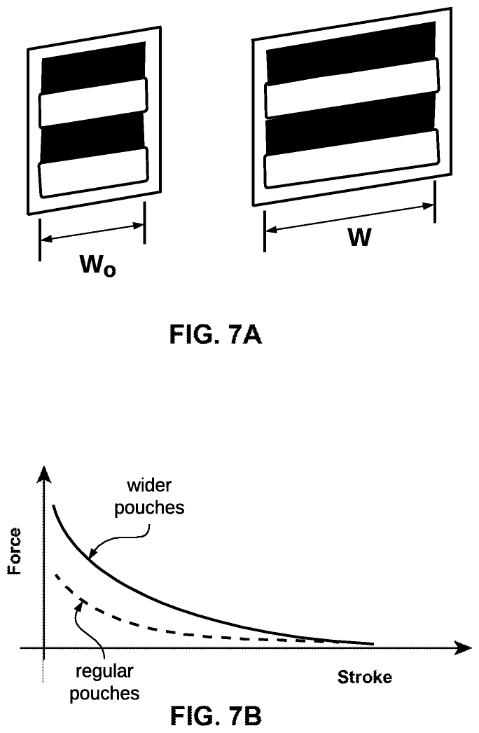

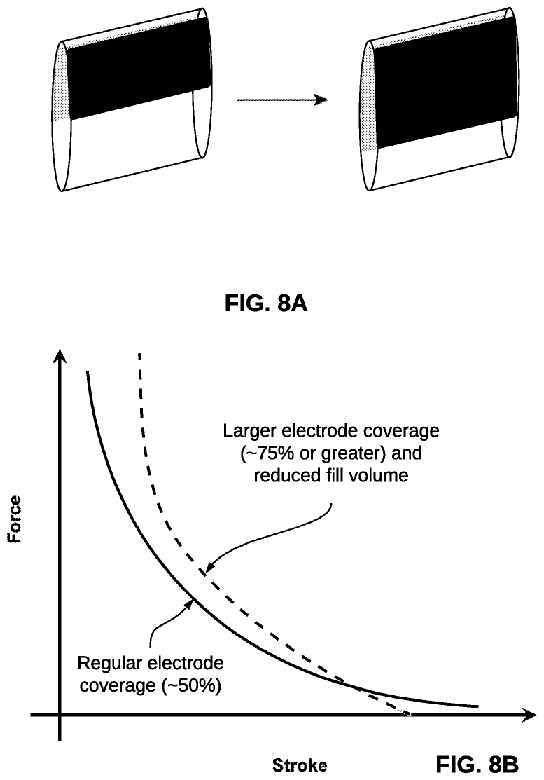

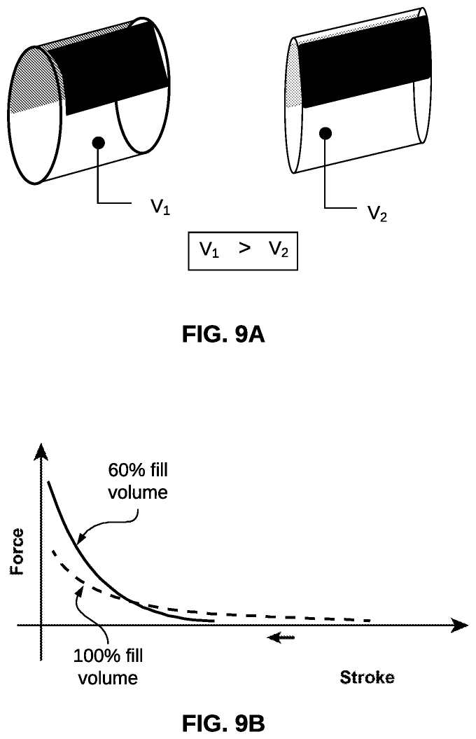

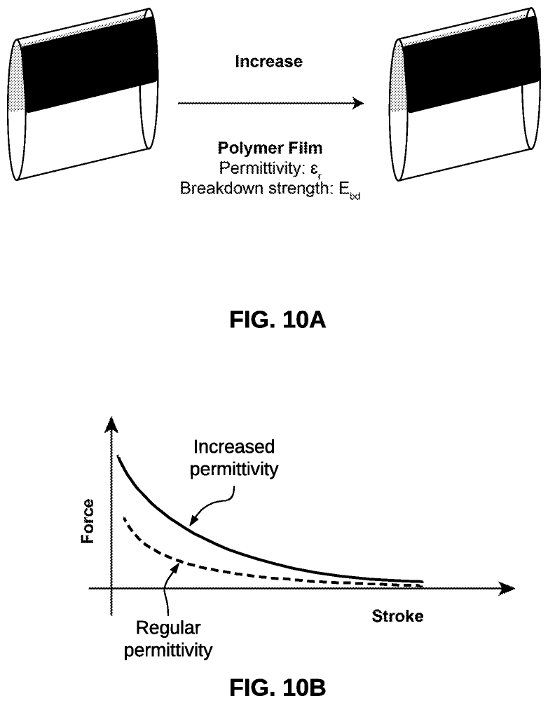

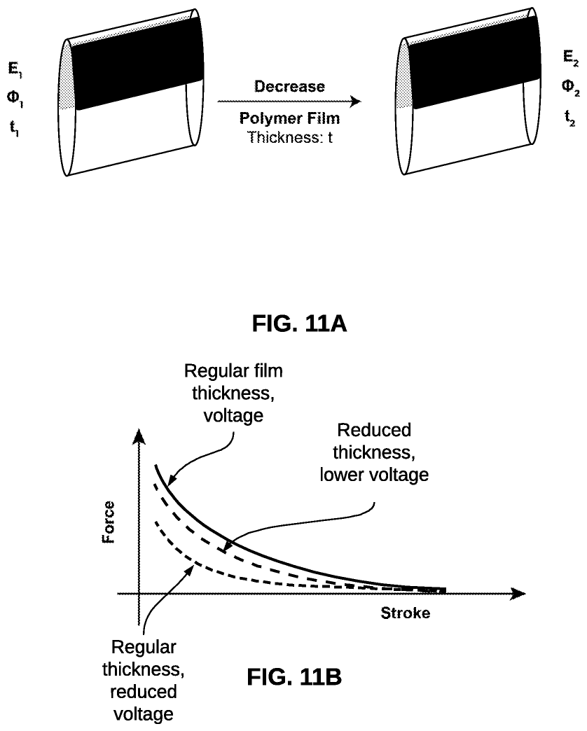

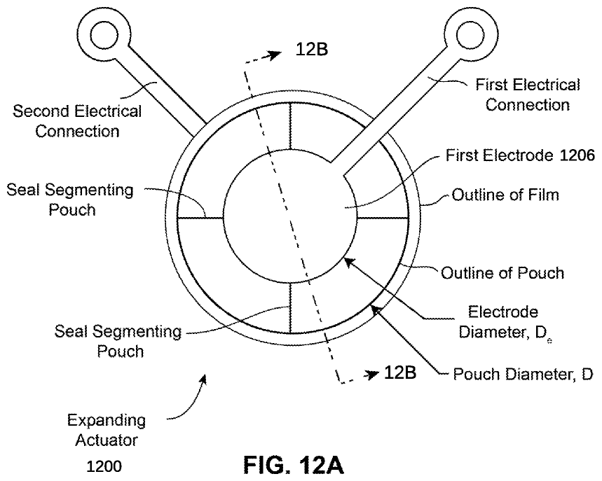

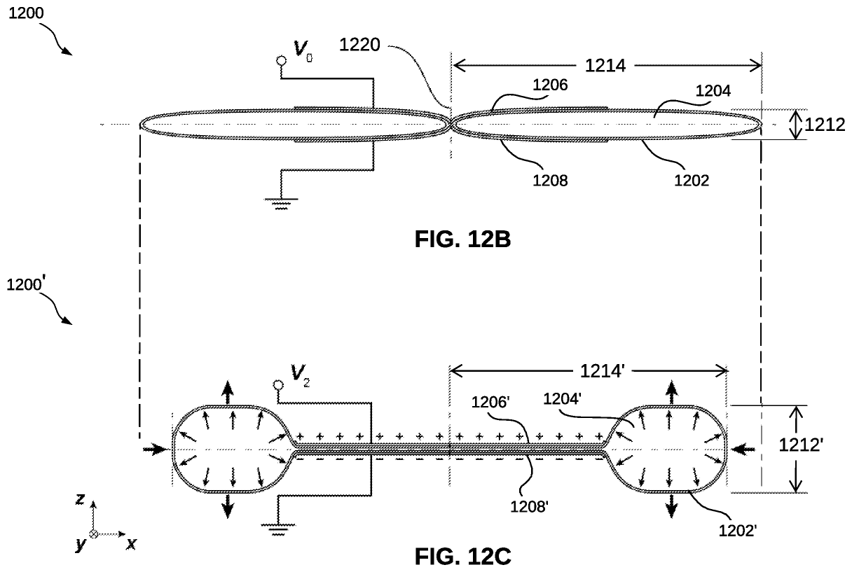

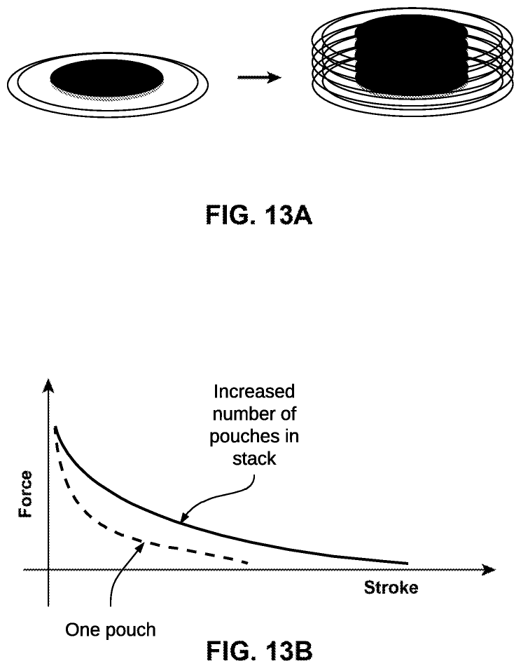

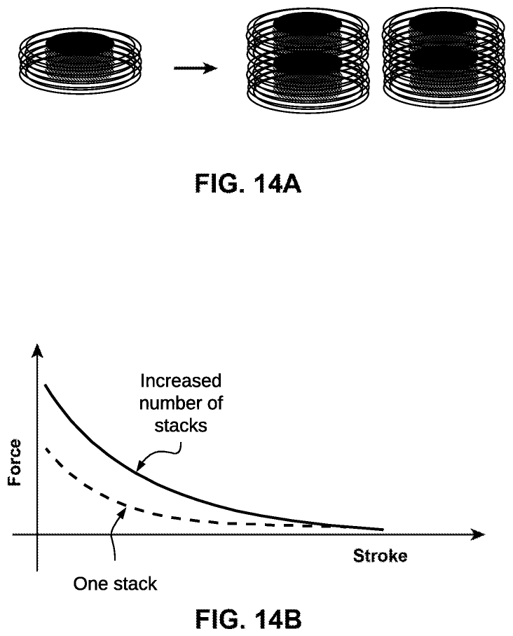

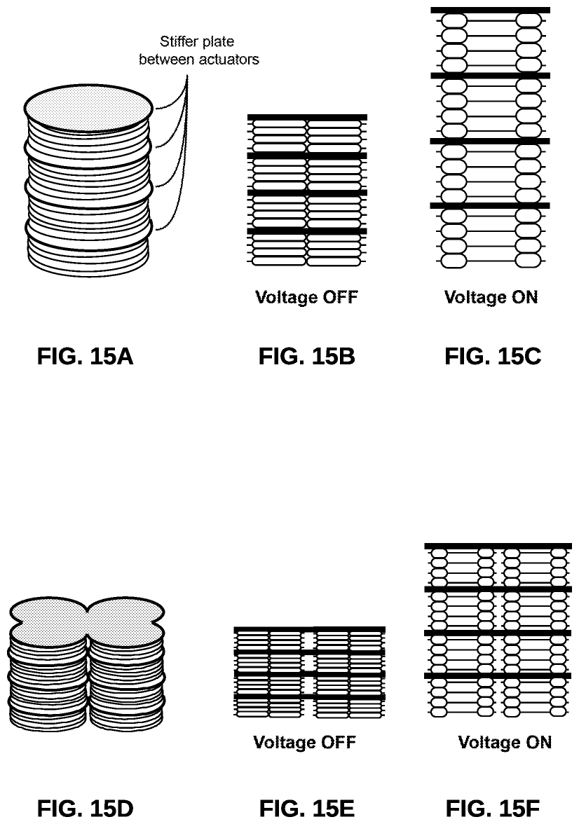

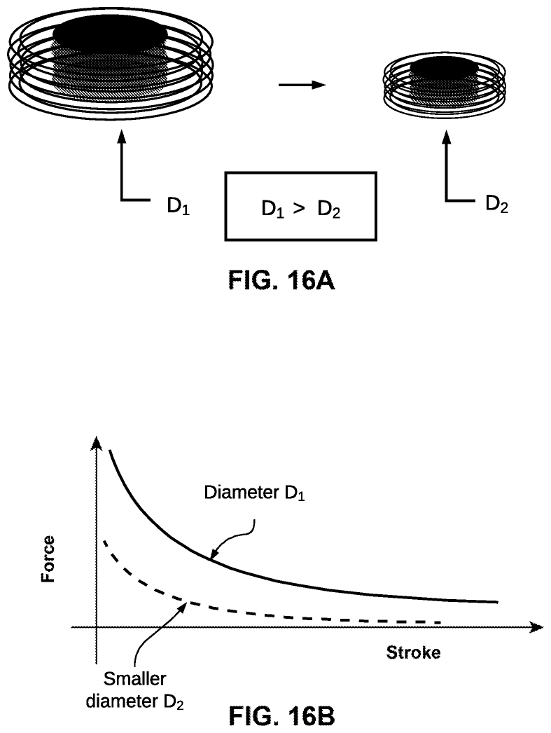

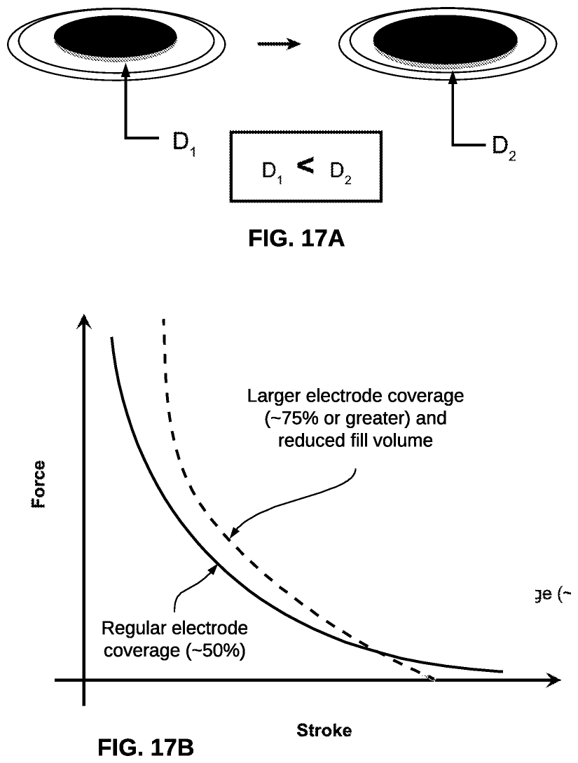

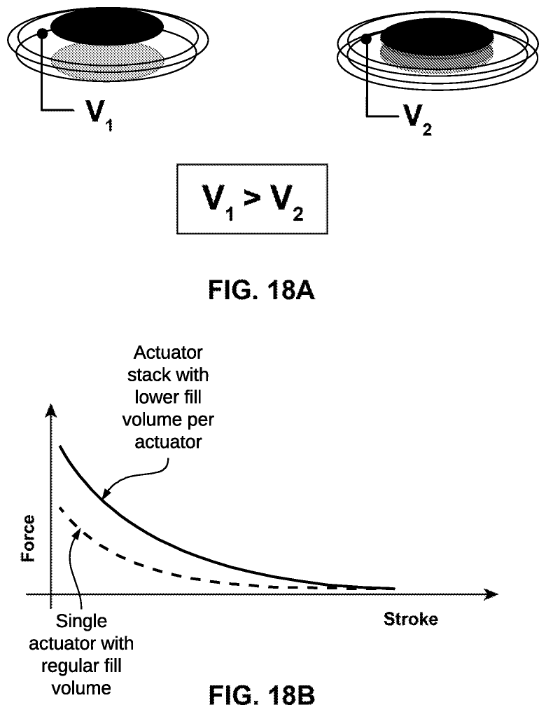

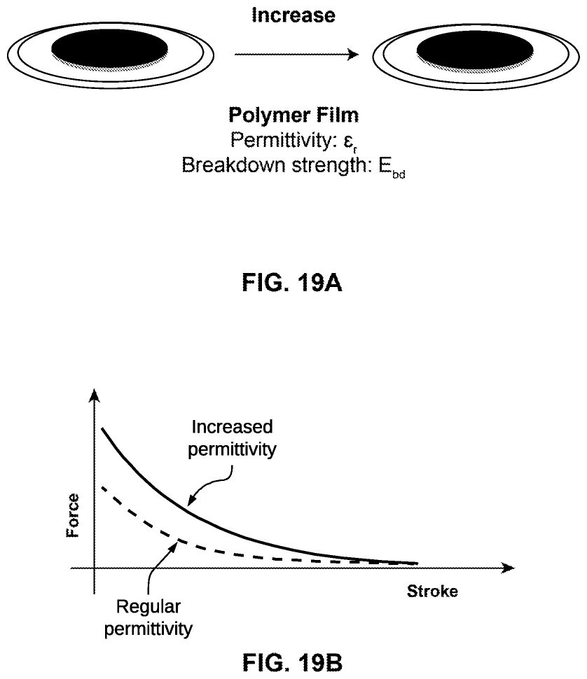

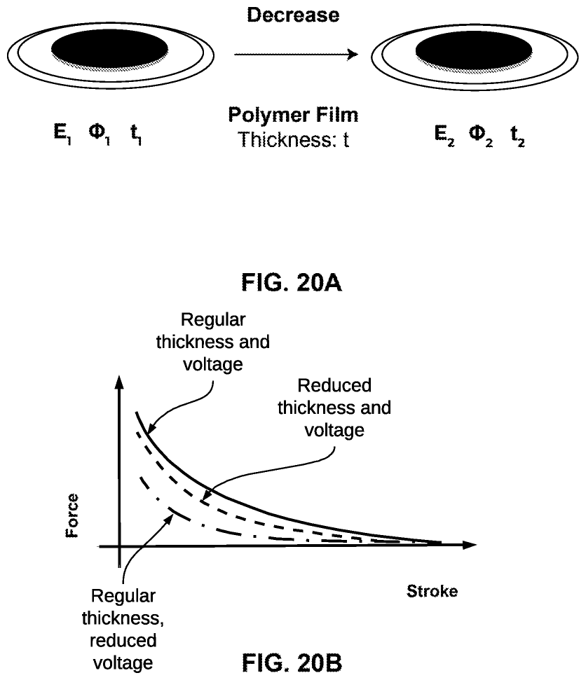

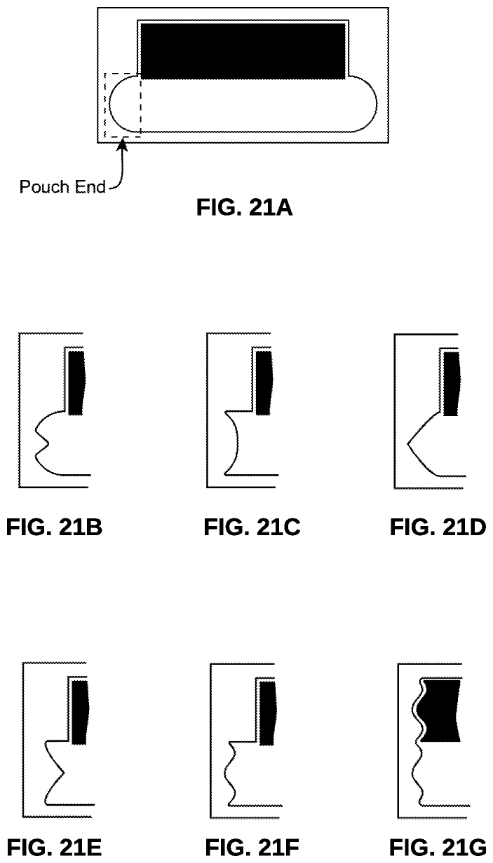

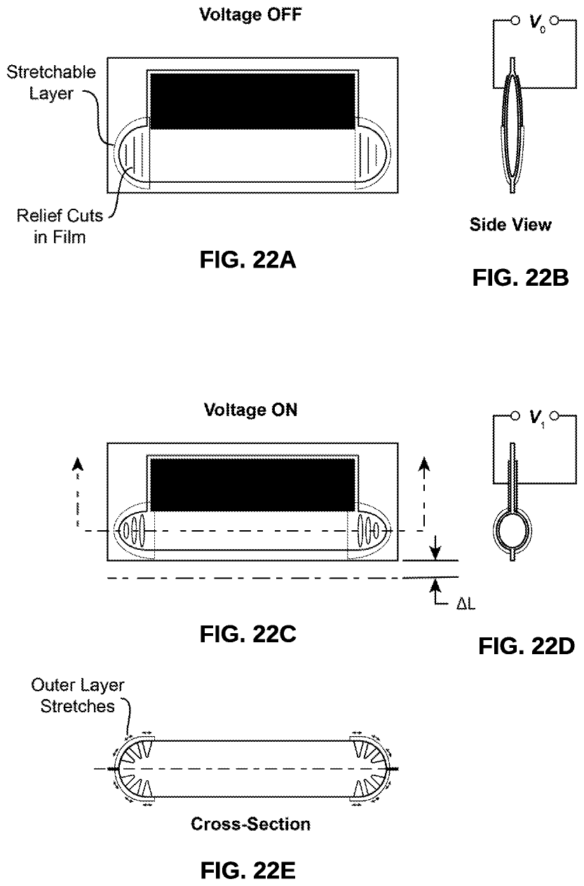

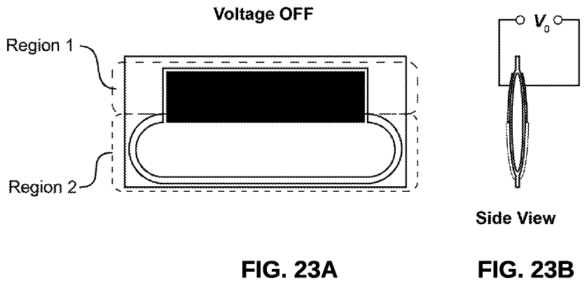

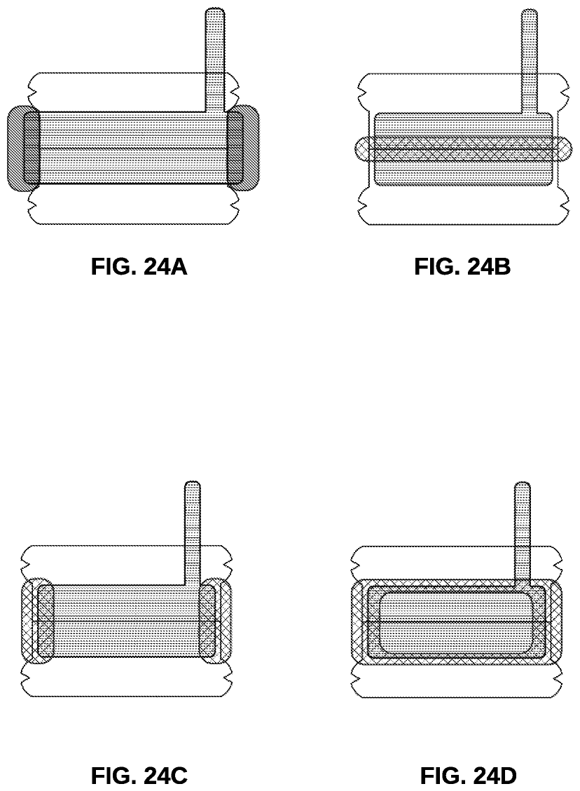

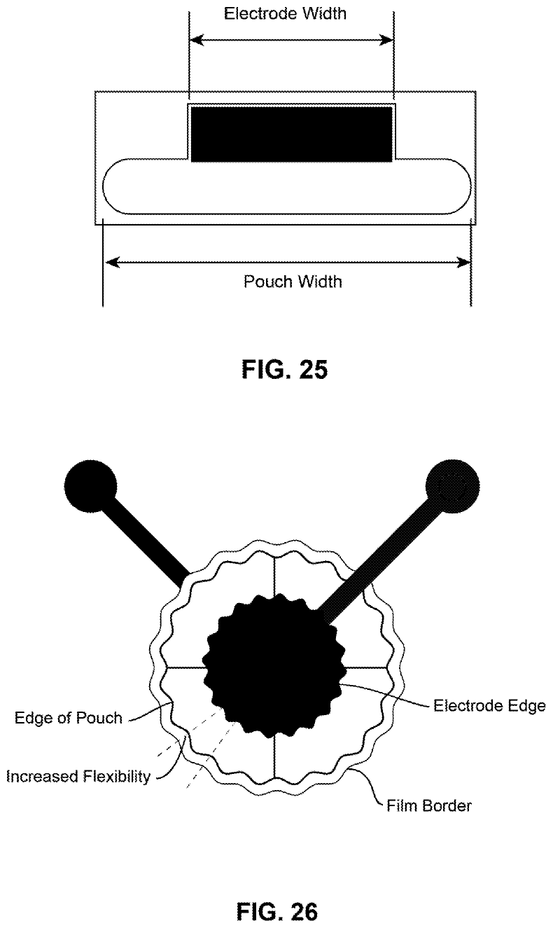

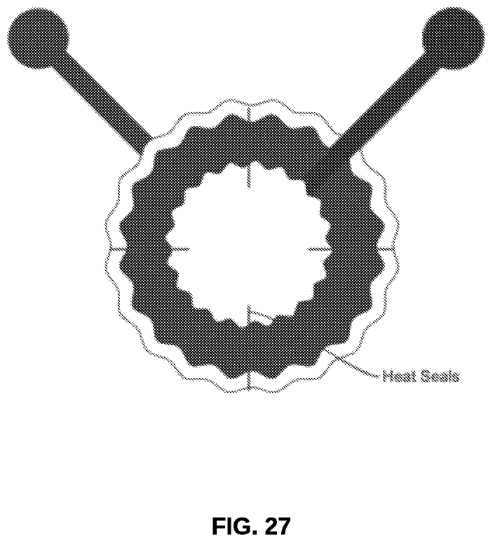

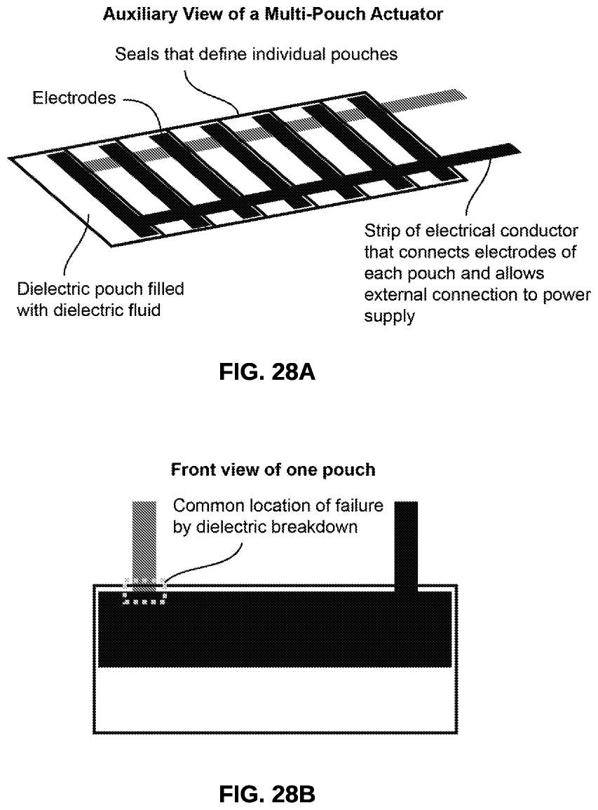

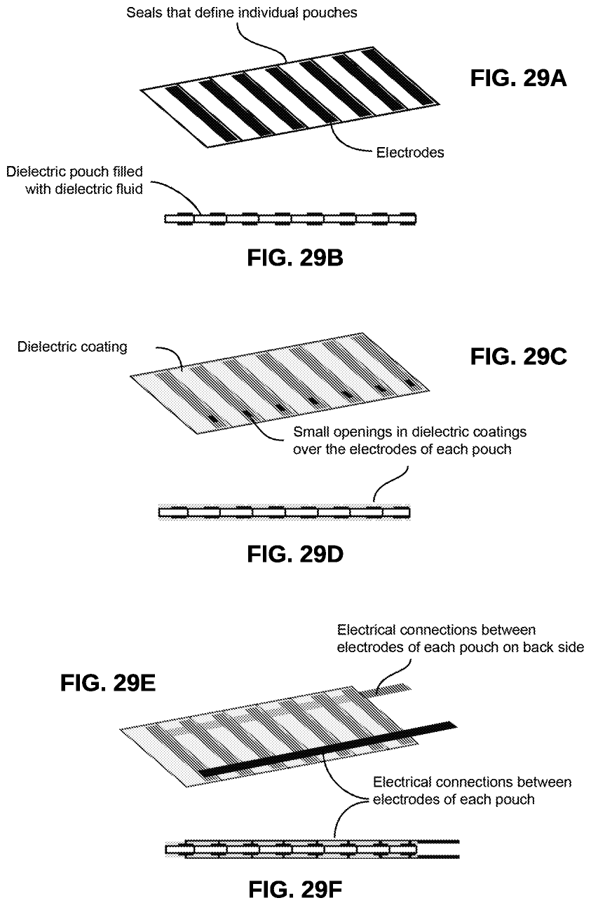

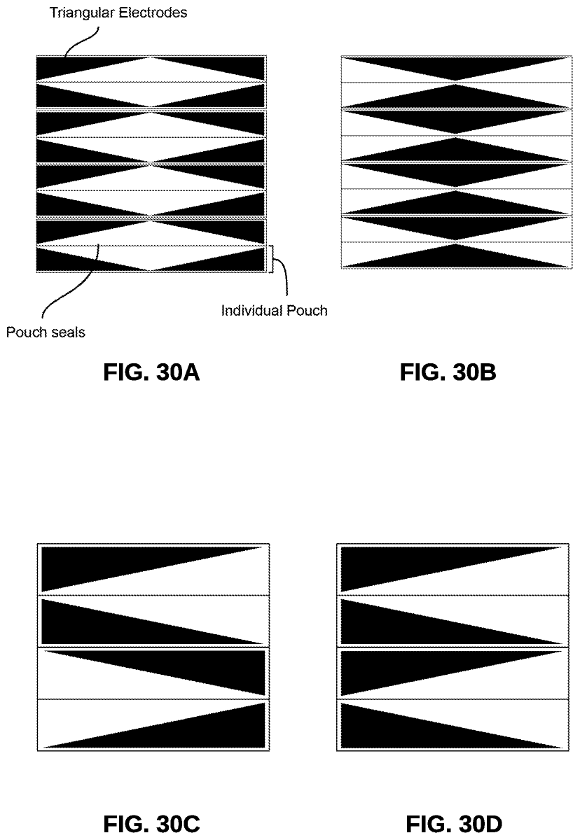

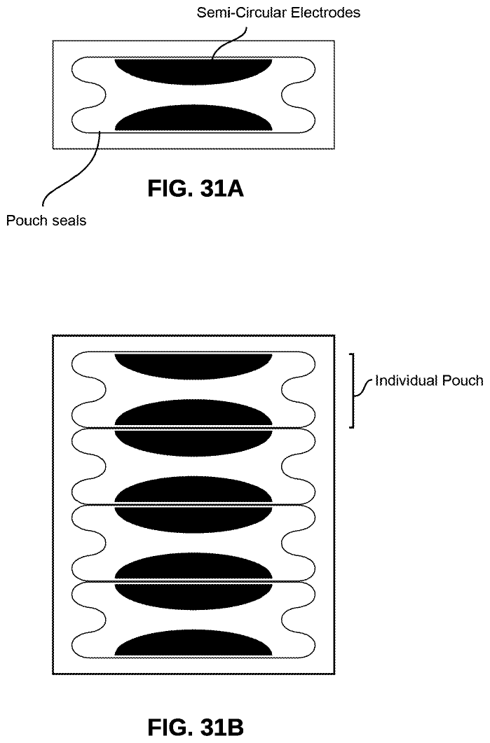

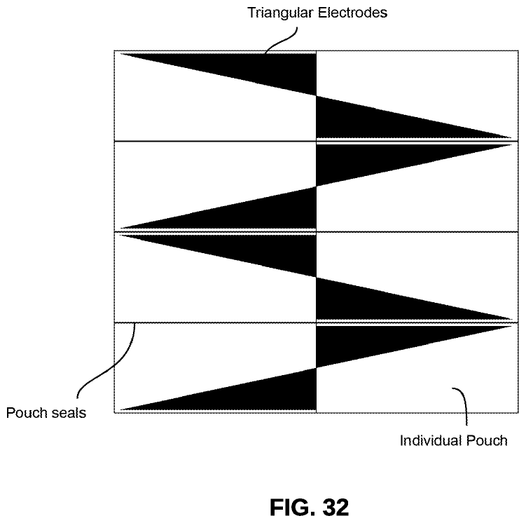

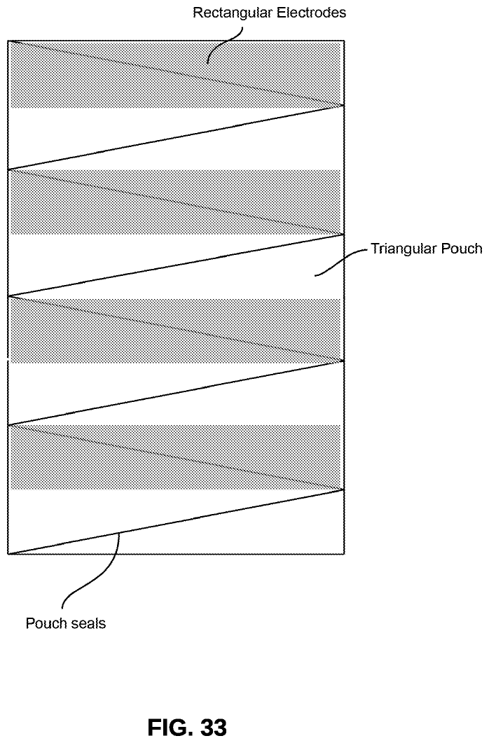

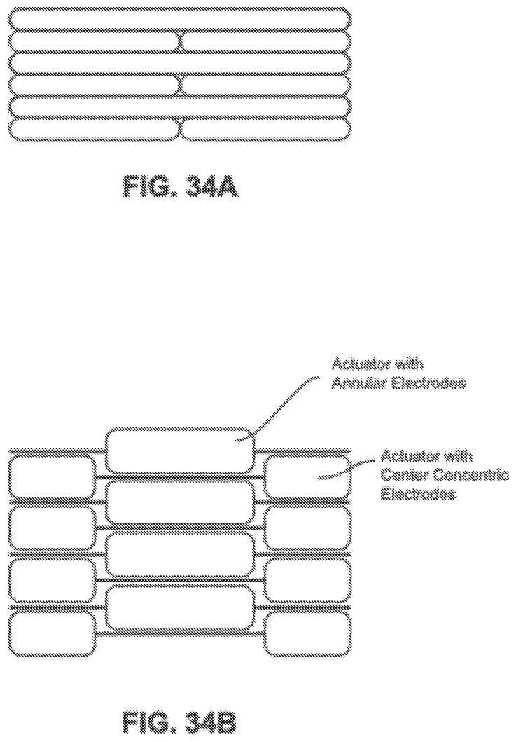

FIGS. 5A and 5B illustrate changes in the performance of contracting actuators when the number of actuators in parallel is modified. Specifically, FIG. 5A shows a perspective view of two additional configurations of contracting HASEL actuators, with a single four-pouch contracting actuator shown on the left side, and an array of four, four-pouch contracting actuators shown on the right side.

FIG. 5B shows a graph of the actuator force as a function of stroke for different numbers of sets of actuators that are stacked in the array. As shown in FIG. 5B, increasing the number of actuators increases actuator force at a given stroke value. In particular, free stroke (i.e., stroke at 0 N force) of the actuator will remain the substantially the same for both the single actuator and the four actuator array, while the actuator force will increase for a given stroke for the four actuator array over the single four-pouch actuator.

It is noted that, when stacking actuators in parallel as shown on the right side of FIG. 5A, the spacing between the actuators may be adjusted for desired effect. For instance, when spaced apart from each other within the array, the actuators in parallel do not necessarily interact or come into contact with each other even when activated. Such a spaced apart configuration may reduce the possibility of abrasion between the actuators in the array, thus helping to preserve the integrity of the actuators, thus potentially increasing the actuator reliability and useful life. On the other hand, having the actuators be placed in closer proximity within the array provides advantages in increased stacking density and force output as well as reduced actuator size. Additionally, lateral force interactions between the actuators within the array may provide hydrostatic leveraging, thus enabling the actuator array to expand laterally on vertical contraction. Detrimental effects, such as abrasion between layers of actuators within the array, may be mitigated through the addition of protective layers (e.g., providing a parylene coating over electrodes for reduced friction).

3) Changing Length of the Pouch

In certain embodiments, decreasing the length of actuator pouches may be an effective method for increasing the energy density of contracting actuators, as illustrated in FIGS. 6A and 6B. FIG. 6A shows a perspective view of two further configurations of contracting HASEL actuators, in accordance with embodiments. The four-pouch actuator shown on the left side of FIG. 6A is substantially similar to those shown in FIGS. 4A and 5A, with four pouches connected in series, and each pouch having a length at rest of La. On the right side of FIG. 6A, an array of two ten-pouch actuators is shown, each one of the ten pouches having a length L smaller than L₀.

FIG. 6B shows a graph of the actuator force as a function of stroke for different pouch lengths used in the actuator configurations. In the illustrated example in FIG. 6B, the total mass and fluid volume contained in the actuators on both actuators shown in FIG. 6A are assumed to be the same. Further, it is assumed that the total length of each actuator in the actuators connected in series is the same.

Generally, by decreasing actuator pouch length while adding more pouches in series, the force-stroke of an actuator remains substantially unchanged, while the actuator volume and mass decreases linearly with pouch length. Thus, more of these actuators with smaller pouches may then be arrayed to increase the force output of HASEL actuators for a given stack volume (See, for example, Kellaris, et al. (reference [1]) cited below).

It is noted that, while maximum actuator stroke should theoretically remain unaffected, stroke values may be decreased due to secondary effects. For instance, as actuator pouch length is decreased, the bending stiffness of actuators substantially increases, primarily in the buckling regions at the sides of the pouch. Such stiffness constraints may affect the free stroke of the actuator. As actuator stroke is a recognized limiting factor in the performance of contracting actuators, the usefulness of this approach of increasing the force performance of the actuators may be limited, in certain embodiments. Further, this method requires an increase in actuator number proportional to the decrease in actuator pouch length, N=N₀*L₀/L. Such increase in actuator number may pose difficulties in the manufacture of the actuator arrays with shorter length pouches.

4) Changing Width of the Pouch

Increasing actuator width increases the output force linearly and is equivalent to arraying more actuators in parallel, as shown in FIGS. 7A and 7B. That is, increasing the width of each actuator pouch increases the active area within the overall mechanical system, thus increasing overall force output of a single- or multi-pouch actuator.

In particular, FIG. 7A shows a perspective view of two more configurations of contracting HASEL actuators, shown here with different widths Wo and W, in accordance with embodiments. FIG. 7B shows a graph of the actuator force as a function of stroke for different pouch widths used in the actuator configurations of FIG. 7A. As can be seen in FIG. 7B, the force and stroke performance of the wider pouches is increased over that of regular width pouches.

It is noted that, as actuator pouch widths are modified, several secondary effects may affect actuation behavior. For example, with decreased pouch width, end constraints in the pouch (i.e., physical behavior of each pouch at the short sides) become more prominent and may act to decrease free stroke and force output in the mid to high stroke region. On the other hand, as actuator pouch width is increased, zipping instabilities become more prominent in the electrode zipping behavior as activation voltage is applied across the electrodes. Such zipping instabilities may act to decrease free stroke while increasing blocked force (See, for example, Rothemund, et al., (reference [2]) cited below). Further, width-scaling may be fundamentally limited by the dimensions of the enclosure in which the actuators are intended to be placed.

5) Increasing Electrode Coverage

Changing the electrode coverage for a pouch will change the force vs. stroke performance. FIG. 8A shows a perspective view of two HASEL actuators with different electrode coverage, in accordance with embodiments. As shown in FIG. 8A, the actuator on the left side includes an electrode covering slightly less than 50% of the pouch surface area, and the actuator on the right side includes larger electrode coverage (e.g., 75% or greater) as a proportion of pouch surface area. The actuator on shown on the right side of FIG. 8A also includes a reduced liquid dielectric fill such that the longer electrodes are able to fully zip together when sufficient voltage is applied thereto.

FIG. 8B shows a graph of the actuator force as a function of stroke for different electrode coverage used in the actuator configurations, such as exemplified in FIG. 8A. The combination of the larger electrode coverage and reduced liquid dielectric fill results in a greater force for a given stroke. It is noted that the larger electrode configuration generally results in reduced free stroke, such that the comparison curves shown in FIG. 8B intersect in the low-force, high stroke regime. This intersection occurs closer to the free stroke of the standard actuator with ˜50% electrode coverage, compared to a simple reduction of liquid dielectric fill without a corresponding increase in electrode coverage, as will be discussed below with respect to FIGS. 9A and 9B.

6) Changing Actuator Fill Volume

Adjusting the amount of liquid dielectric in each pouch changes the electromechanical coupling in contracting actuators via geometric changes within the pouch, as illustrated in FIGS. 9A and 9B. FIG. 9A shows a perspective view of two HASEL actuators with different fill volumes, in accordance with embodiments. On the left side of FIG. 8A, a HASEL actuator has been filled with liquid dielectric to essentially 100% of the fill capacity of the pouch, i.e., to a volume necessary to transition the portion of the pouch (also referred to as deformable shell) to a complete cylinder when the electrodes are fully zipped together. That is, ideally when the electrodes are fully zipped together, the liquid-filled portion of the pouch has a substantially circular cross-section. Such “deal” fill volumes may prevent further pressurization by the electrostatic forces provided by the electrodes such that the resulting pouch shape would be stable. On the right side, a HASEL actuator is shown filled to approximately 60% of the fill capacity, as is normally done with standard HASEL actuators. FIG. 9B shows a graph of the actuator force as a function of stroke for different fill volumes used in the actuator configurations.

In general, reducing the volume of liquid dielectric in a pouch decreases the electrode zipping angle, which increases force output at the expense of free stroke, as may be seen in FIG. 9B. Overall, the energy density of actuators increases with this method since the actuator volume decreases for reduced liquid dielectric fill. Similar to decreasing pouch length, reducing liquid dielectric fill allows for increased stacking density to increase actuation stress and overall force output.

It is recognized herein that reducing liquid dielectric fill to <60% of the “ideal” fill amount negatively impacts the maximum stroke of the actuator, limiting the utility of this method for substantial performance improvements, in embodiments. A trade-off of underfilling actuators is sacrificing maximum stroke, as may be seen in FIG. 9B. However, in contrast to modeling results, testing of physical actuators shows that actuation stroke does not actually decrease when varying fill from 60% to 100% of the full amount, making this a promising method for increasing force output.

7) Changing Dielectric Properties of the Film

The force output of contracting actuators scales approximately according to F∝εᵣE² where εᵣ is relative permittivity of the film and E is the applied electric field or applied voltage divided by total thickness of dielectric between the electrodes. One of the most promising methods for increasing the force output of contracting actuators is to increase either the permittivity of the polymer film used, thus enabling the application of increased electric field, as illustrated in FIGS. 10A and 1013.

FIG. 10A shows a perspective view of two HASEL actuators with different pouch film dielectric properties, in accordance with embodiments. The left side of FIG. 10A shows a standard HASEL actuator including a pouch formed using a film with a normal permittivity value. The right side of FIG. 10A shows a HASEL actuator formed of a polymer film with an increased permittivity, thus leading to an increased breakdown strength E_{bd} for the film.

FIG. 10B shows a graph of the actuator force as a function of stroke for different film dielectric properties used in the actuator configurations. As can be seen in FIG. 1013, force should theoretically scale linearly with the permittivity of the polymer film and quadratically with the applied electric field (and voltage). Therefore, it would be desirable to find polymer films with high permittivity and/or high dielectric breakdown strength to tolerate application of higher electric fields. Due to the quadratic relationship with electric field, small gains in applied electric field may lead to large performance increases.

It is recognized herein that material properties are similarly important in achieving lower operating voltages for actuators, which may be required for certain applications. In embodiments, high permittivity films may allow for a similar output force at a lower electric field and thus lower voltage. That is, materials with higher breakdown strength may enable HASEL actuators that can operate at higher electric fields. In conjunction with the implementation of a thinner film to form the pouch for containing the dielectric fluid, such materials may yield an actuator operable at a lower voltage without sacrificing output force.

7) Changing Thickness of the Film

HASEL actuators generally require high electric fields (˜100 V/μm) to operate, which translates to the need to apply voltages in the range of several kilovolts. One potentially simple method for decreasing the voltage required to operate the HASEL actuators is by decreasing the film thickness, since F∝tεᵣE² and E=Φ/2t in a simple model of HASEL actuators assuming there is no liquid dielectric in the zipped region of the films. In this equation, t is the thickness of the polymer film and Φ is the applied voltage across the electrodes. Therefore, proportionally decreasing the film thickness and voltage should maintain the same electric field for a lower voltage.

FIG. 11A shows a perspective view of two HASEL actuators with different pouch film thicknesses, in accordance with embodiments. The actuator on the left side of FIG. 11A is subjected to an electric field ε₁, at applied voltage Φ₁ with a pouch film thickness t₁. Similarly, the actuator on the right side of FIG. 11A is subjected to an electric field E₂, at applied voltage Φ₂ with a pouch film thickness t₂.

FIG. 11B shows a graph of the actuator force as a function of stroke for different film thicknesses used in the actuator configurations as well as applied voltage values. As can be seen in FIG. 11B, an actuator at voltage Φ₁, with film thickness t₁ (i.e., the left side of FIG. 11A) will have a force output curve (labeled as curve 1 in FIG. 11B). Decreasing voltage and film thickness by the same proportion to a lower voltage Φ₂ and film thickness t₂ will decrease the force output linearly while allowing for decreased operating voltage (labeled as curve 2 in FIG. 11B). By comparison, reducing voltage to Φ₂ while keeping thickness the same, t₁, will quadratically decrease force output (labeled as curve 3 in FIG. 11B).

Fundamentals of Expanding Actuators

Another commonly used configuration of HASEL actuators is an expanding actuator. For instance, an expanding actuator configuration may include a generally circular pouch with one or more pairs of a generally circular electrode disposed on opposing sides of the pouch. An example is shown in FIG. 12A, which shows a top view of a circular expanding HASEL actuator, in accordance with embodiments. It is noted that, while the following exemplary embodiments are discussed in terms of generally circular configurations, other shapes and configurations of pouches and electrodes are also contemplated and considered a part of the present disclosure.

An actuator 1200 of FIG. 12A includes a circular pouch with diameter D, which is divided into four sections by seals that segment the pouch. It is also notable that the pouch diameter D is smaller than an outline of the film used to form the pouch, as the pouch diameter is defined by a seal formed in the film; that is, a “skirt” of extra film material may surround the pouch diameter. These seals can be formed by a variety of methods and can extend across the entire diameter or only a portion of the pouch. For example, the segmentation of the pouch may be configured for directing the flow of liquid dielectric contained therein as voltage is applied via the first and second electrical connections.

FIG. 12B illustrates a cross-sectional view of actuator 1200, viewed along a dashed line A-A indicated in FIG. 12A. As visible in FIG. 12B, actuator 1200 includes a pouch 1202 filled with a liquid dielectric 1204 and sandwiched between a first electrode 1206 and a second electrode 1208. In an example, FIG. 12B shows actuator 1200 in a rest state where little or no voltage V₀ is applied thereto. As shown in FIG. 12B, actuator 1200 exhibits a thickness 1212 and a radius 1214 about a center line 1220.

In embodiments, the center of the pouch diameter (i.e., at center line 1210) may be sealed together to create an initiation point for zipping of the electrodes. Circular electrodes with diameter D e are located in the middle of the pouch and are typically concentric with the circular pouch. The electrodes can also be located off-center of the pouch, cover only a portion of the pouch, or be an annular shape where the outer diameter is the same as the pouch diameter D. First and second electrical connections (not shown in FIG. 12B) extend past the perimeter of the pouch, making it simple to apply voltage across the actuator.

FIG. 12C shows a cross-sectional view of the circular expanding HASEL actuator of FIGS. 12A and 12B, shown here with a voltage V₂ applied thereto. In particular, FIG. 12C shows actuator 1200′ once a voltage V₂ (where V₂>>V₀) has been applied and the electrodes have fully zipped together. This zipping motion has caused the actuator radius to reduce to 1214′, while the actuator thickness has increased to 1212′.

Modifying Performance of Expanding Actuators

Performance characteristics of expanding actuators may be tailored by modification of various parameters, in a manner similar to those described with respect to contracting actuators. Some examples are described below.

1) Changing Number of Expanding Actuators in Series

One method for improving the stroke output of expanding actuators is by stacking multiple actuators, thus increasing the overall stack height while providing higher stroke at a given force. FIG. 13A shows a perspective view of two configurations of HASEL actuators with different numbers of actuators in each configuration, in accordance with embodiments, with a single actuator on the left side of FIG. 13A and a stack of five actuators shown on the right side of FIG. 13A.

FIG. 13B shows a graph of the actuator force as a function of stroke for different numbers of actuators stacked in the actuator configurations. In the illustrated embodiment, the actuator blocked force will essentially stay the same. Also, for the same force, stroke will increase proportional to the number of actuators added (N/N₀). This approach works well for expanding actuators since their aspect ratio is such that they are much wider than they are tall, thus several actuators may be stacked within a relatively small vertical space. For example, this approach may be useful for applications that require large displacement, particularly for those applications that require large displacement with lower force with limited space in the plane perpendicular to the expanding direction.

2) Changing Number of Expanding Actuators in Parallel

Another approach toward increasing the force output of expanding actuators is by using additional actuator stacks, e.g., in multiple columns. FIG. 14A shows a perspective view of two configurations of HASEL actuators with different numbers of actuators and stacks in each configuration, in accordance with embodiments. In this approach, the overall stroke of the system will remain unchanged, and the force output for a given stroke will increase in direct proportion to the number of actuator stacks in parallel.

FIG. 14B shows a graph of the force as a function of stroke for different numbers of actuator stacks. Due to the high width-to-height ratio of expanding actuators, increasing force output by adding more actuator stacks in parallel may be impractical due to the large area footprint this creates. For example, this approach may be useful for applications requiring high force output with limited space in the direction of actuator expansion. In particular, if the space perpendicular to the expansion direction is unlimited, it is possible to use large arrays of actuators to produce a very large force output. In applications where multiple degrees of freedom (DOF) are needed, actuators are often placed with no additional lateral space between stacks, which would preclude the implementation of this approach.

3) Adding Stiffer Plates Between Actuators

As described above, expanding actuators may be effectively stacked to increase stroke. However, as actuators are stacked together, instabilities between pouches may limit the number of actuators that may be used to achieve stroke increase proportional to the number of actuators added. One way to address this deficiency is by incorporating stiffer plates between single actuators or stacks of actuators. The basic concept of using stiffer separators between actuators to improve mechanical coupling was previously discussed in Mitchell et al. (See reference [3] cited below).

In certain embodiments, instead of or in addition to the stiff plates, one or more stabilizing braces or another stabilization mechanism (such as stiff or flexible tubing or a stretchable material) may be implemented to assist in the stabilization of stacked actuators, without the need to affix (e.g.,) the actuators together. For example, an encapsulated segment of two or more actuators with a stabilization mechanism may be formed, then multiple encapsulated segments may be stacked or used in parallel to increase stroke or force in a stable way.

FIG. 15A shows a perspective view of a column of HASEL actuators including stiff plates interspersed therein, in accordance with embodiments. As shown in FIG. 15A, the column of HASEL actuators includes a circular, stiffer plate between every four expanding HASEL actuators. The stiffer plate, in this exemplary embodiment, is shaped to generally cover the circular surface of the HASEL actuator when the actuator is in the rest position, as shown in FIG. 15B with the voltage turned off. Other shapes, such as square, oval, rectangular, and others, may be contemplated depending, for example, on the object onto which force from the actuators is to be imparted. For instance, the stiff plate at the top of the actuator column may be shaped to present a button-on-demand through a fabric or cover when activated, where the button may have a desired shape and texture (e.g., ridges and bumps) according to the design of the stiff plate.

FIG. 15C shows a cross-sectional view of the stack of HASEL actuators of FIGS. 15A and 15B, shown here with voltage turned on. As shown, the stack of HASEL actuators have increased in height, while the actuator diameters have slightly reduced (generally on the order of 1% or less in this circular actuator configuration). The stiff plates provided between every four actuators help provide stability and uniformity in the generated force provided by the configuration illustrated in FIGS. 15A-15C.

This approach can be applied to individual stacks (FIG. 15A), arrays of stacks (FIG. 15B), or even single layers of actuators (not shown). The stiffer plates may be formed, for example, with shapes that mimic the shape of each actuator, such as the circular expanding actuators illustrated above. The stiffer plates may also be shaped to cover multiple actuators for distribution of force between different actuators, such as for more even distribution of force as applied to an external object.

FIG. 15D shows a perspective view of a four-column configuration of HASEL actuators including stiff plates interspersed therein, in accordance with embodiments.

FIG. 15E shows a cross-sectional view of the four-column configuration of HASEL actuators of FIG. 15E, shown here with voltage turned off.

FIG. 15F shows a cross-sectional view of the four-column configuration of HASEL actuators of FIGS. 15D and 15E, shown here with voltage turned on. The four stacks shown in FIG. 15D may be activated together to impart a uniform upward force, as shown in FIG. 15F. Alternatively, different combinations of actuators may be activated to present different amounts of force, tilting of the actuator columns, and other types of motion. For instance, by sequentially activating each column of actuators, a rotating motion may be imparted at the top stiff plate.

In embodiments, the stiffer plates may extend beyond the profile of the actuators themselves so as to direct the forces created by the actuators to a location beyond the immediate proximity of the actuators. For example, one or more of the stiffer plates may include an arm to direct the forces created by the actuator or actuator stack toward a remote location as a lever effect. Other shapes beyond those shown in FIGS. 15A-15F may be contemplated and are considered to be a part of the present disclosure.

4) Changing Pouch Diameter

Changing the diameter of expanding actuator pouches will modify both their force and stroke behavior. FIG. 16A shows a perspective view of two configurations of HASEL actuators with different diameters in each configuration, in accordance with embodiments. The actuator stack on the left of FIG. 16A has a larger diameter than the stack on the right side of FIG. 16A.

FIG. 16B shows a graph of the actuator force as a function of stroke for different diameters of actuators in the configurations. As shown, the larger diameter actuator stack provides greater force and stroke output.

That is, decreasing pouch diameter will result in both lower force and stroke output due to the smaller electrode area and smaller actuating area. Smaller actuators can be desirable for creating additional degrees of freedom in a system that is space constrained. For instance, smaller diameter actuators may be stacked in series to increase stroke output to compensate for the lower inherent stroke. Increasing pouch diameter will conversely increase both force and stroke output, although a larger diameter actuator stack can take up more area.

The energy density of expanding actuators should increase linearly with decreasing pouch diameter. However, it is recognized herein that mechanical constraints due to film stiffness may prevent these gains in energy density from being fully realized. Multi-material systems that utilize more compliant materials in the expanding region of the pouch are an approach to addressing this issue. Another approach would be to combine a smaller or larger diameter actuator with stiffer plates (e.g., as shown in FIGS. 15A-15F) or other modification approaches as described herein.

One problem often encountered with expanding actuators is the tendency of each actuator to buckle near the edges, along the outer perimeter of the pouch. For instance, as expanding actuator pouch diameter is decreased, the bending stiffness of actuators increases substantially, primarily in the buckling regions at the edges of the pouch. This effect can reduce the free stroke of the actuator. To counter this problem, thinner materials may be used for the pouches. In addition to varying the material properties in the expanding region, the pouch shape may be modified to add compliance to the buckling regions of the structure, as shown in FIGS. 26A-26B described below.

Changing actuator diameter will also modify the bandwidth of the actuators. For example, smaller diameter actuators may be useful for applications requiring high frequency movement. That is, as a pouch with smaller diameter displaces less fluid during actuation, and the actuator may correspondingly exhibit higher bandwidth in the actuation.

Conversely, as actuator diameter is increased, zipping instabilities can make actuation less consistent compared to actuators with smaller diameters. Larger diameter pouches also have substantially more liquid dielectric fill, which will tend to “pool” in the lowest potential region and make large diameter actuators sensitive to changes in orientation relative to the ground. For instance, an actuator stack positioned with the column oriented perpendicular to the ground may exhibit different performance behavior from when the actuator stack is positioned with the column oriented parallel to the ground surface. This issue may be addressed by adding more features to constrain the liquid dielectric. For example, additional segmenting seals can be added to the pouch diameter. In this case, the mechanical constraints in an actuator are ideally tuned to the dimensions of the pouch to provide enough stiffness to suppress instabilities while still allowing a large free stroke. Similarly, as shown in FIG. 12A, segmenting seals may be configured to segment the pouch into smaller sections such that, while the pouch itself may operate as a normal HASEL actuator, the dielectric liquid is contained in smaller segmented sections within the pouch, thus making such a configuration less sensitive to changes in actuator orientation.

5) Increasing Electrode Coverage

Changing the electrode coverage for a pouch will change the force vs. stroke performance. FIG. 17A shows a perspective view of two expanding HASEL actuators with different electrode coverage, in accordance with embodiments. As can be seen in FIG. 17A, the actuator on the right side of the figure has a larger diameter electrode than the actuator on the left side of the figure. As noted above with respect to FIGS. 8A-8B, the volume of the liquid dielectric fill may be reduced correspondingly to enable the larger diameter electrode to fully zip together upon application of voltage across the electrodes.

FIG. 17B shows a graph of the actuator force as a function of stroke for different electrode coverage used in the expanding actuator configurations. The actuator with more electrode coverage will achieve higher free stroke than the actuator with a smaller electrode, assuming the volume of liquid dielectric selected such that so that the larger electrodes can zip together fully. That is, the actuator on the right side of FIG. 17A may be limited to a smaller volume of liquid dielectric compared to the actuator on the left side.

6) Changing Actuator Fill Volume

In fact, adjusting the amount of liquid dielectric in the actuator pouch also affects the actuator performance. Generally, modifying the amount of liquid dielectric fill in the pouch changes the electromechanical coupling in expanding actuators due to geometric changes within the pouch. For example, FIG. 18A shows a perspective view of two expanding HASEL actuators with different fill volumes, in accordance with embodiments. On the left hand side of FIG. 18A, a single actuator with slightly increased fill volume compared to a standard HASEL actuator is shown. On the right hand of FIG. 18A is shown a stack of two actuators, each actuator having a reduced fill volume compared to a standard HASEL actuator, the stack having the same overall mass and volume as the single actuator on the left hand side.

FIG. 18B shows a graph of the actuator force as a function of stroke for different fill volumes used in the expanding HASEL actuator configurations. Reducing the volume of liquid dielectric in a pouch decreases the electrode zipping angle (see FIGS. 2A and 2B), which increases force output at the expense of maximum stroke. Overall, the energy density of actuators increases with this method since the actuator volume decreases for reduced liquid dielectric fill. That is, for the same overall mass and volume, a higher performance may be achieved with a stack of two actuators with reduced fill volumes as a single actuator with higher fill volume.

For expanding actuators, it is particularly easy to stack more actuators in series (i.e., one circular actuator on top of another) due to their favorable width-to-height ratio. By stacking more actuators in series, the same stroke can be maintained while increasing force output of the stack by increasing the number of actuators in the stack (N) in proportion a decrease in actuator fill volume to maintain the same overall stroke output, N₂=N₁*V₁/V₂.

It is recognized herein, however, that there is a limit to the beneficial effects that can be attained by reducing the liquid dielectric fill volume. As actuator fill volume decreases below a certain limit (e.g., approximately a quarter of “ideal” fill), the effect of stray capacitance in the unzipped region leads to inconsistent actuation and increased effects of charge retention which prevents relaxation of the actuator under low loads.

7) Changing Dielectric Properties of the Film

Another approach to modifying the performance of the HASEL actuator is by changing the dielectric properties of the film used to form the pouch. As described above with respect to the contracting actuators, the force output F of expanding actuators scales approximately according to F a εᵣE² where εᵣ is relative permittivity of the film and E is the applied electric field or applied voltage divided by total thickness of dielectric between the electrodes. One promising approach toward increasing the force output of expanding actuators is to increase the permittivity of the polymer film used and/or the applied electric field. FIG. 19A shows a perspective view of two expanding HASEL actuators with different pouch film permittivity values, in accordance with embodiments.

FIG. 19B shows a graph of the actuator force as a function of stroke for different film permittivity values used in the expanding HASEL actuator configurations. As in the contracting HASEL actuator embodiments, forming the pouch from a film with a higher permittivity and/or high dielectric breakdown strength would enable the actuators to operate at higher electric fields and/or lower voltages without sacrificing output force.

8) Changing Thickness of the Film

As described above with respect to contracting HASEL actuators, HASEL actuators require high electric fields. Again, decreasing the film thickness and voltage proportionally should maintain the same electric field for a lower voltage. FIG. 20A shows a perspective view of two expanding HASEL actuators with different pouch film thicknesses, in accordance with embodiments. FIG. 20B shows a graph of the actuator force as a function of stroke for different film thicknesses used in the expanding HASEL actuator configurations for three scenarios: 1) An actuator at Voltage 1, Φ₁, with film thickness t₁; 2) a version with decreased voltage and film thickness by the same proportion to Voltage 2, Φ₂, and t₂, and 3) with reduced voltage Φ₂ while keeping thickness at t₁. As can be seen in FIG. 20B, scenario 2 yields nearly similar performance as scenario 1 with regular film thickness and voltage, even with reduced voltage. There is a significant decrease in the force/stroke performance when the voltage is reduced without an adjustment in the film thickness.

Reducing Actuator Constraints

Most geometries of HASEL actuators are constrained by the bending stiffness of the actuator film and other components of the shell that forms a pouch. These constraints may decrease the force and stroke of actuators, particularly at the higher stroke region of their force vs stroke performance curves. These specific types of constraints in the pouch of HASEL actuators may be managed in various as ways, as described herein, thus making it easier for the HASEL actuator pouches to take on three-dimensional such as circular cross-sectional shape when activated.

FIG. 21A shows a contracting HASEL actuator with a rounded pouch end portion, in accordance with embodiments. Since the films are flexible but not stretchable, this shape is constrained and prevents the pouch from taking a circular shape once the electrodes zip together fully.

FIGS. 21B-21G illustrate various options for modifying the pouch end of rectangular HASEL actuators to reduce the bending stiffness constraint of the rounded pouch end configuration. These configurations may be particularly useful for actuators used for contraction in the length direction, as well as expansion in the thickness direction.

For example, FIG. 21B shows a contracting HASEL actuator with a notched pouch end portion, in accordance with embodiments.

FIG. 21C shows a contracting HASEL actuator with an inwardly-curved pouch end portion, in accordance with embodiments.

FIG. 21D shows a contracting HASEL actuator with a pointed pouch end portion, in accordance with embodiments.

FIG. 21E shows a contracting HASEL actuator with an inwardly-notched pouch end portion, in accordance with embodiments.

FIG. 21F shows a contracting HASEL actuator with a scalloped pouch end portion, in accordance with embodiments.

FIG. 21G shows a contracting HASEL actuator with a scalloped pouch end portion as well as electrode edge, in accordance with embodiments.

These shapes shown herein include combinations of concave and convex curves and cut-outs on the pouch edge. The shapes may be along only the portion of the pouch length that is not covered by electrodes (e.g., FIGS. 21B-21F) or it may include the electrode region (e.g., FIG. 21G) to reduce constraints throughout the full actuator stroke.

Additional modifications may be integrated into the pouch design to decrease mechanical constraints at the pouch ends. FIGS. 22A-22E illustrate the use of relief cuts and/or a stretchable material in the pouch ends. FIG. 22A shows a front view of a contracting HASEL actuator including relief cuts, in accordance with embodiments. In particular, the actuator of FIG. 22A includes vertical relief cuts in the film layer at the bulbous end portions of the pouch. To seal the liquid inside of the pouch and provide mechanical support, a stretchable layer is placed over the film forming the pouch. When the electrodes zip together, the relief areas of the pouch end are able to separate, and this deformation allows the pouch ends to take on an ideal hemispherical shape.

FIG. 22B shows a cross-sectional view of the contracting HASEL actuator of FIG. 22A, without a voltage applied thereto. As can be seen in FIG. 22B, the electrodes are not yet zipped together with no voltage applied thereto.

FIGS. 22C and 22D show a front view and a cross-sectional side view, respectively, of the contracting HASEL actuator of FIGS. 22A and 22B, with a voltage applied thereto.

FIG. 22E shows a cross-sectional bottom view of the pouch portion of the contracting HASEL actuator of FIGS. 22C and 22D with applied voltage. As can be seen in FIG. 22E, the ends of the pouch are able to expand to an ideal semi-spherical shape, with assistance from the relief features.

Another approach is shown in FIGS. 23A and 23B, which illustrate an actuator with different materials in the electrode region (region 1) and the uncovered region (region 2). In particular, FIG. 23A shows a front view of a contracting HASEL actuator including two different materials in the electrode and uncovered regions, in accordance with embodiments. FIG. 23B shows a cross-sectional side view of the contracting HASEL actuator of FIG. 23A.

It is recognized herein that the material properties required in the electrode region differ from those in the uncovered region of an actuator. As such, different materials may be used in these regions for optimal properties of each region. For example, materials in the electrode region should have good properties as a dielectric, while materials in the uncovered region do not require high permittivity or breakdown strength. Materials in region 2 should generally be more flexible to enable the pouch to take on an ideal circular cross-section and achieve more stroke and force. On the other hand, materials in region 2 may be tuned for other purposes such as increased reliability or increased stiffness.

Dielectric coatings may be added to actuators help prevent failure and allow operation at higher voltages which increases reliability and performance. It is recognized, however, that dielectric coatings may exacerbate the mechanical constraint at specific portions of the actuators, so it is not optimal to cover an entire pouch with a dielectric coating. FIGS. 24A-24D illustrate various implementations of selectively patterned dielectric layers around the edges of the electrodes to reduce the effects of electric field concentrations at these locations.

For example, FIG. 24A shows a front view of a rectangular HASEL actuator including a dielectric coating, in accordance with embodiments. As shown in FIG. 24A, a dielectric coating (such as a solid dielectric or oil pouch, shown as darker vertical ovals) is added to the sides of the active pouches to increase electrode separation at the edges and prevent the presence of electrode edges in the zipped region of the electrodes.

FIG. 24B shows a front view of a rectangular HASEL actuator including a dielectric applied under the electrodes over the heat seal portion, in accordance with embodiments. In particular, as shown in FIG. 24B, a dielectric coating (shown as a horizontal, cross-hatched oval) is applied under the electrodes over the heat seal to reduce electric stress in the heat seal which often has a larger defect concentration and higher electric stress due to reduced thickness.

FIG. 24C shows a front view of a rectangular HASEL actuator including a dielectric applied under the electrode edges, in accordance with embodiments. In the embodiment of FIG. 24C, a dielectric coating (shown as two vertical cross-hatched ovals) is applied under the electrode edges at the sides where failure most often occurs as this is the area where the electrode edges are zipped most often leading to higher electric stress. It is noted that, unlike the embodiment shown in FIG. 24A, the electrode of FIG. 24C do not protrude outward from the edges of the pouch.

Finally, FIG. 24D shows a front view of a rectangular HASEL actuator including an annular dielectric pattern, in accordance with embodiments. Particularly, FIG. 24D shows an annular dielectric coating (shown as a cross-hatched oval) covering the outer edges of the main area of the electrode. Such a dielectric coating may help to shield the electrode edges from creating high electric stress in the actuator.

FIG. 25 shows a front view of a rectangular HASEL actuator including a wide pouch, in accordance with embodiments. In particular, FIG. 25 illustrates a rectangular actuator where the pouch width is much larger than electrode width. Much larger pouch width reduces end constraints. Additionally, while the skirt (i.e., the rectangular outline around the pouch and electrode) is shown as a rectangle in FIG. 25, the skirt can be trimmed closer to the outline of the pouch, which will further decrease the mechanical constraints at the pouch edges.

FIG. 26 shows a top view of a circular HASEL actuator including a scalloped edge, in accordance with embodiments. That is, the circular actuator of FIG. 26 includes edge geometry that is configured to be favorable for buckling. Instead of a smooth circular shape, the outer edge of the electrode, pouch, and film border have a zig-zag type pattern alternating between localized convex and concave shapes. The concave regions allow for increased flexibility to help the edges to buckle, thus increasing force and stroke performance.

It should be appreciated that the area covered by electrode can be inverted for circular actuators, as shown in FIG. 27. In this case, heat seals may need not intersect at the center of the pouch to allow for expansion of the central region. That is, to allow the center of the pouch to expand, the heat seals do not extend through the center of the pouch.

FIGS. 28A and 28B illustrate common failure points for contracting actuator pouches connected in series. In particular, FIG. 28A shows a perspective view of a multi-pouch actuator, with multiple actuator pouches connected in series. FIG. 28B shows a front view of a portion of an actuator pouch with another view of a common location of failure.

When multiple contracting actuator pouches are connected in series, each pouch is partially covered by a pair of electrodes. A strip of electrical conductor may be used to connect the electrodes together, thus enabling application of voltage thereto. A common location of failure by dielectric breakdown is the transition region between the electrode and connector (FIG. 28B). This failure point limits the maximum voltage that can be applied and overall reliability. Preventing failures at this point will increase reliability and allow for higher force and stroke performance.

FIGS. 29A-29F illustrates an approach for coating electrodes in encapsulation with windows on top to allow jumpers to connect all electrodes to common potential. In an embodiment, FIG. 29A illustrates a perspective view of multiple actuators connected in series, with a cross-sectional view shown in FIG. 29B. The electrodes are printed on individual pouches, and are not initially connected.

FIG. 29C shows a perspective view of the actuators of FIG. 29A with a dielectric coating, in accordance with embodiments. FIG. 29D shows a cross-sectional view of the actuators of FIG. 29C. The dielectric coating is applied on the electrodes and pouch, with small openings in the dielectric coatings over the electrodes of each pouch.

FIG. 29E. shows the actuators of FIG. 29C with electrodes connected therewith, in accordance with embodiments, with a cross-sectional view shown in FIG. 29F. As shown in FIGS. 29E and 29F, electrical connections are applied on top of the dielectric coating. These connections make contact with electrodes on each pouch through the small openings illustrated in FIGS. 29C and 29D. This approach eliminates the transition failure seen in actuators during lifetime cycling tests.

Variations in Actuator Shape

The shape of HASEL actuators can be easily modified for different performance or form factor requirements. Some changes to pouch shape and/or electrode shape can also contribute to reducing constraints and improving overall stroke and force performance.

FIGS. 30A-30D illustrate four variations of contracting actuators with rectangular pouches and triangular electrodes. FIG. 30A shows an array of rectangular actuators with triangular electrodes, in accordance with an embodiment. In particular, FIG. 30A illustrates pouches that include triangular electrodes configured to zip from the side and transverse edge of each pouch, while the middle region of the pouch is not covered with electrodes. This configuration allows the middle to deform into a circular shape more easily.

FIG. 30B shows an array of rectangular actuators with an alternative arrangement of triangular electrodes, in accordance with an embodiment. In this configuration, essentially showing an inverted version of the actuator of FIG. 30A, the electrodes are configured to zip through the middle section of each pouch, while the edges are not covered with electrodes. This configuration reduces the constraints on the edges of the pouch allowing them to more easily take on a circular shape when activated with the application of a voltage. FIGS. 30C and 30D show additional variations of rectangular pouches with triangular electrodes.

FIG. 31A shows an actuator pouch with semi-circular electrodes and rounded pouch edges, in accordance with an embodiment. The semicircular electrodes cause the majority of bending to occur in the middle of the pouch where the structure is more flexible, while the pouch ends may deform with a larger radius of curvature than earlier illustrated pouch ends with a convex rounded shape.

FIG. 31B shows multiple actuators of FIG. 31A, connected in series. In this configuration, pouch end features help to reduce mechanical constraints on the end. This design may be useful for applications requiring more stroke and/or force, for example.

FIG. 32 shows an array of rectangular actuators with triangular electrodes, in accordance with an embodiment. Particularly, FIG. 32 illustrates a contracting actuator with rectangular pouches and generally triangular electrodes. A seal in the center of the pouches separates the actuator into a left and right half. The triangular electrodes alternate between the left and right side periodically. Such an arrangement may be useful in customizing the contracting motion of the actuator.

FIG. 33 shows an array of triangular actuators with rectangular electrodes, in accordance with an embodiment. That is, unlike the embodiments illustrated above, the actuator pouches are triangular, while the electrodes are rectangular. In this configuration, the electrodes zip from the sides as well as the diagonal heat seal line.

FIGS. 34A-34B illustrate a column of expanding actuators including alternating annular (e.g., as shown in FIG. 27) and center concentric (e.g., as shown in FIG. 26) electrodes, shown with no voltage applied in FIG. 34A and with applied voltage in FIG. 34B. By alternating between the two electrode configurations, the alternating actuators nest together during actuation, which eliminates any dead space that occurs when actuators expand and thus more efficiently use the volume of the column of actuators when activated. This configuration may be particularly useful for applications that have limited total volume or requirements for constant volume stacks of actuators.

Additional modifications of the various components of HASEL actuators are contemplated. For example, one or both of the electrodes to manipulate the direction and strength of electric fields established within the pouch. It is recognized herein that the electric field is amplified at edges and corners of the electrodes. While such areas of field concentration may be points of failure as described above, strategic patterning of the electrodes may enable refined manipulation of the electric fields and, thus, behavior of the HASEL actuator upon application of a voltage thereacross.

As examples, modification of a variety of parameters for adjusting the operational performance of HASEL actuators is contemplated, such as the implementation of one or more of the following:
1) Modifying the length, width, and/or diameter of the deformable shell;
2) Modifying the length, width, and/or diameter of at least one of the first and second electrodes;
3) Modifying the ratio of area covered by the first and second electrodes with respect to a surface area of the deformable shell;
4) Modifying the ratio of the length, width, and diameter of the deformable shell with respect to the length, width, and diameter of at least one of the first and second electrodes;
5) Modifying the ratio of a volume of the fluid dielectric to a volume capacity of the enclosed internal cavity;
6) Modifying the permittivity of at least a portion of the film forming the deformable shell;
7) Modifying the thickness of at least a portion of the film forming the deformable shell;
8) Using different materials forming the deformable shell under at least one of the first and second electrodes compared to the portion of the deformable shell in areas not covered by the first and second electrodes;
9) Configuring an edge of the deformable shell to encourage predetermined deformation behavior, such as including one or more relief cuts, adding reinforcement materials or features to protect known areas of material weakness, providing a stretchable layer covering a portion of the deformable shell, configuring a portion of the deformable shell to include shaped features such as a notch, an arc, a point, a wave, a scalloping, and other shapes;
10) Configuring an edge of at least a portion of the one of the electrodes to include shaped features such as a notch, an arc, a point, a wave, a scalloping, and other shapes;
11) Partially or completely partitioning the internal cavity defined by the deformable shell to encourage the flow of the dielectric liquid in specific directions;
12) Providing a stiff plate adjacent to the actuator;
13) Providing one or more pairs of additional electrodes on the same deformable shell;
14) Shaping the electrodes and deformable shells to promote specific movement of the actuator when activated; and
15) Patterning one or both of the electrodes to manipulate the direction and strength of electric fields established within the pouch (e.g., a patterned electrode on one side with a solid electrode on the opposing side, or a patterned electrode on both sides).

In systems with multiple actuators, additional modifications may include one or more of the following:
1) Providing additional deformable shells connected in series and/or parallel (e.g., stacked);
2) Providing multiple stacks of actuators;
3) Providing a stiff plate adjacent to one or more of the multiple actuators, such as at the top of two stacked or adjacent actuators, in between stacked actuators at periodic intervals, etc.;
4) Providing a stiff plate across two or more of the multiple actuators;
5) Providing electrode connections configured to prevent dielectric breakdown at the interconnection points;
6) Providing an external cover around two or more adjacent actuators or actuator stacks; and
7) Shaping the electrodes and deformable shells to promote specific motion of the multiple actuators, such as combining triangular electrodes with rectangular deformable shells, staggering the shape of the electrodes, stacking actuators with different electrode configurations.

The following references may provide a background for the disclosure above:
[1] Kellaris, Nicholas, et al. “An analytical model for the design of Peano-HASEL actuators with drastically improved performance.” Extreme Mechanics Letters 29 (2019): 100449.
[2] Rothemund, Philipp, Nicholas Kellaris, and Christoph Keplinger. “How inhomogeneous zipping increases the force output of Peano-HASEL actuators.” Extreme Mechanics Letters 31 (2019): 100542.
[3] Shane K. Mitchell, Xingrui Wang*, Eric Acome*, Trent Martin, Khoi Ly, Nicholas Kellaris, Vidyacharan Gopaluni-Venkata, Christoph Keplinger. “An Easy-to-Implement Toolkit to Create Versatile and High-Performance HASEL Actuators for Untethered Soft Robots”. Advanced Science 6(14) 1900178 (2019).

The foregoing is illustrative of the present disclosure and is not to be construed as limiting thereof. Although a few exemplary embodiments have been described, those skilled in the art will readily appreciate that many modifications are possible in the exemplary embodiments without materially departing from the novel teachings and advantages of the present disclosure.

Accordingly, many different embodiments stem from the above description and the drawings. It will be understood that it would be unduly repetitious and obfuscating to literally describe and illustrate every combination and subcombination of these embodiments. As such, the present specification, including the drawings, shall be construed to constitute a complete written description of all combinations and subcombinations of the embodiments described herein, and of the manner and process of making and using them, and shall support claims to any such combination or subcombination

1. A method for adjusting an operational performance of an actuator system, the method comprising:
providing an actuator including
a deformable shell defining an enclosed internal cavity,
a fluid dielectric contained within the enclosed internal cavity,
a first electrode disposed over a first side of the enclosed internal cavity, and
a second electrode disposed over a second side of the enclosed internal cavity;
providing a power source for providing a voltage across the enclosed internal cavity between the first and second electrodes; and
adjusting the operational performance of the actuator by modifying at least one of:
a length, width, diameter, and shape of the deformable shell,
a length, width, diameter, and shape of at least one of the first and second electrodes,
a ratio of area covered by the first and second electrodes to a surface area of the deformable shell,
a ratio of the length, width, and diameter of the deformable shell to the length, width, and diameter of at least one of the first and second electrodes,
a ratio of a volume of the fluid dielectric to a volume capacity of the enclosed internal cavity,
a permittivity of at least a portion of the deformable shell,
a thickness of at least a portion of the deformable shell,
a material forming the deformable shell under at least one of the first and second electrodes,
a material forming the deformable shell in areas not covered by the first and second electrodes,
at least one edge configuration of the deformable shell,
an edge configuration of at least one of the first and second electrodes, and
a partition within at least a portion of the deformable shell,
wherein the operational performance includes force provided by the actuator as a function of stroke, actuator breakdown strength, direction of actuation, uniformity of deformation of the deformable shell, actuator flexibility, and stroke as a function of actuator system volume.

2. The method of claim 1, further comprising providing a stiff plate adjacent to the actuator for transmitting force therethrough.

3. The method of claim 2, further comprising:
providing additional actuators; and
configuring the stiff plate to also be adjacent to the additional actuators.

4. The method of claim 1, further comprising:
modifying a shape of a portion of the deformable shell to promote the deformable shell to take on a predefined shape upon application of the voltage across the enclosed internal cavity.

5. A method for operating an actuator system, the method comprising:
providing an actuator including
a deformable shell defining an enclosed internal cavity,
a fluid dielectric contained within the enclosed internal cavity,
a first electrode disposed over a first side of the enclosed internal cavity, and
a second electrode disposed over a second side of the enclosed internal cavity;
providing a power source for providing a voltage across the enclosed internal cavity between the first and second electrodes such that the actuator system including the actuator and the power source exhibits a first operational performance; and
modifying at least one of a length, width, diameter, and shape of the deformable shell, a length, width, diameter, and shape of at least one of the first and second electrodes, a volume of the fluid dielectric, a permittivity, a thickness, and a material of at least a portion of the deformable shell, and a partition within at least a portion of the deformable shell such that the actuator system so modified exhibits a second operational performance,
wherein the operational performance includes force provided by the actuator as a function of stroke, actuator breakdown strength, direction of actuation, uniformity of deformation of the deformable shell, actuator flexibility, and stroke as a function of actuator system volume.

6. The method of claim 5, wherein modifying includes providing a second actuator disposed adjacent to the actuator, first mentioned, wherein the second actuator is connected in series with the actuator, first mentioned.

7. The method of claim 5, wherein modifying includes providing a second actuator disposed adjacent to the actuator, first mentioned, wherein the second actuator is connected in parallel with the actuator, first mentioned.

8. The method of claim 7, further comprising providing a stiff plate disposed over both the actuator, first mentioned, and the second actuator for transmitting force from the actuator, first mentioned, and the second actuator therethrough.
